(19) United States
(12) Patent Application Publication
(10) Pub. No.: US 2015/0210592 A1
(43) Pub. Date: Jul. 30, 2015

(54) REACTIVE LIMESTONE AS A STRATEGY TOWARDS SUSTAINABLE, LOW-CARBON CEMENTS

(71) Applicants: The Regents of the University of California, Oaklland, CA (US); Arizona Board of Regents, Scottsdale, NJ (US)

(72) Inventors: Gaurav Sant, Los Angeles, CA (US); Magdalena Balonis-Sant, Los Angeles, CA (US); Narayanan Neithalath, Chandler, AZ (US)

(21) Appl. No.: 14/422,867

(22) PCT Filed: Aug. 23, 2013
(86) PCT No.: PCT/US2013/056493

§ 371 Date: Feb. 20, 2015

Related U.S. Application Data
(60) Provisional application No. 61/692,606, filed on Aug. 23, 2012.

(51) Int. Cl. C04B 7/34; C04B 7/02

(52) U.S. Cl. CPC C04B 7/34; C04B 7/02

(57) ABSTRACT

A manufacturing process of a “low cement content” concrete includes: (1) forming a cementitious mixture by combining a cement, a carbonate source, and an aluminous source; and (2) curing the cementitious mixture to form the concrete. The carbonate source is included in an amount greater than 20% by weight of solids combined in the cementitious mixture.

### CROSS-REFERENCE TO RELATED APPLICATION

This application claims the benefit of U.S. Provisional Application No. 61/692,606 filed on Aug. 23, 2012, the disclosure of which is incorporated herein by reference in its entirety.

### STATEMENT REGARDING FEDERALLY SPONSORED RESEARCH OR DEVELOPMENT

This invention was made with Government support of Grant No. CMMI-1066583, awarded by the National Science Foundation. The Government has certain rights in this invention.

### FIELD OF THE INVENTION

The invention generally relates to cements and, more particularly, to low-clinker factor cements.

### BACKGROUND

The rapid rate of infrastructure development in many parts of the world has resulted in an enormous demand for portland cement. In order to reduce its environmental impact, both in terms of CO₂ emissions and energy consumption, it is desired that the clinker factor of cement be reduced. A number of strategies predominantly based on the use of high volumes of cement replacement materials such as fly ash and blast furnace slag have been practiced by the concrete industry to reduce cement use in concrete.

In recent years there has been increased interest in the use of limestone (CaCO₃) powder as a partial cement replacement material. Limestone has the advantages of being abundant, inexpensive, and avoiding the environmental costs associated with portland cement. ASTM standards historically allowed up to 5% limestone (mass basis) in cement, and it has been shown that such low replacement levels can result in comparable or better properties as compared to plain cements. Recently ASTM C 595-12 has specified a Type IL cement that can include up to 15% of limestone powder (mass basis) as a cement replacement material. Unfortunately, high replacement levels by limestone can compromise properties, such as in terms of strength reduction.

It is against this background that a need arose to develop the low-clinker factor cements described herein.

### SUMMARY

One aspect of this disclosure relates to a manufacturing process of a “low cement content” product. In one embodiment, the manufacturing process includes: (1) forming a cementitious mixture by combining a cement, a carbonate source, and an aluminous source; and (2) curing the cementitious mixture to form the product, which can be cement paste, mortar, or concrete. The carbonate source is included in an amount greater than 20% by weight of solids combined in the cementitious mixture.

In another embodiment, the manufacturing process includes: (1) forming a cementitious mixture by combining (a) a cement in an amount corresponding to 30% to 80% by weight of solids in the cementitious mixture, (b) an aluminous source, and (c) a carbonate source in an amount corresponding to at least 40% of a remaining weight of solids combined with the cement; and (2) curing the cementitious mixture to form the product.

Another aspect of this disclosure relates a “low cement content” concrete. In one embodiment, the concrete is formed by: (1) forming a cementitious mixture by combining a cement, a carbonate source, and an aluminous source; and (2) curing the cementitious mixture to form the concrete. The carbonate source is included in an amount greater than 20% by weight of solids combined in the cementitious mixture.

In another embodiment, the concrete is formed by: (1) forming a cementitious mixture by combining (a) a cement in an amount corresponding to 30% to 80% by weight of solids in the cementitious mixture, (b) an aluminous source, and (c) a carbonate source in an amount corresponding to at least 40% of a remaining weight of solids combined with the cement; and (2) curing the cementitious mixture to form the concrete.

Other aspects and embodiments of this disclosure are also contemplated. The foregoing summary and the following detailed description are not meant to restrict this disclosure to any particular embodiment but are merely meant to describe some embodiments of this disclosure.

### BRIEF DESCRIPTION OF THE DRAWINGS

For a better understanding of the nature and objects of some embodiments of this disclosure, reference should be made to the following detailed description taken in conjunction with the accompanying drawings.

FIG. 1: Phase-description diagrams showing the volume of phases as a function of: (a) cement replacement by limestone alone (SO₃/Al₂O₃=about 0.56). The cement content is progressively decreased from 100% to 60% (mass basis), and (b) cement replacement by alumina for a fixed limestone content (40%; mass basis). The cement content is progressively decreased from 60% to 45% (mass basis). The figures illustrate the role of the constituent chemistry on the reaction product volume. This description indicates full thermodynamic equilibrium, namely the cement and alumina are fully reacted in the system.

FIG. 2: Particle size distributions of: (a) limestone (LS) powders and (b) cement, fly ash, and metakaolin.

FIG. 3: Influence of limestone (LS) fineness on the heat release rate. Representative heat flow curves are shown. The uncertainty in the heat flow is less than about 2% based on measurements on triplicate specimens.

FIG. 4: 1-Day compressive strengths of binary and ternary blends of limestone (LS) and fly ash (FA)/metakaolin (MK).

FIG. 5: Influence of limestone (LS) dosage on heat release rates for pastes including: (a) about 0.7 μm limestone powder, (b) about 3 μm limestone powder, and (c) about 15 μm limestone powder. Representative heat flow curves are shown. The uncertainty in the heat flow is less than about 2% based on measurements on triplicate specimens.

FIG. 6: Influence of w/c ratio on the calorimetric response of OPC pastes. Representative heat flow curves are shown. The uncertainty in the heat flow is less than about 2% based on measurements on triplicate specimens.

FIG. 7: 1-Day CH contents for selected binary and ternary pastes.

FIG. 8: calorimetric response of: (a) fly ash (FA) modified pastes, (b) metakaolin (MK) modified pastes, (c) ternary mixtures of about 10% limestone (LS) and about 10% fly ash, (d) ternary mixtures of about 20% limestone and about 10% fly ash, (e) ternary mixtures of about 10% limestone and about 10% metakaolin, and (f) ternary mixtures of about 20% limestone and about 10% metakaolin. Representative heat flow curves are shown. The uncertainty in the heat flow is less than about 2% based on measurements on triplicate specimens.

FIG. 9: Compressive strength development of: (a) OPC-limestone (LS) pastes, (b) OPC-limestone-fly ash (FA) pastes, and (c) OPC-limestone-metakaolin (MK) pastes. The standard deviation in compressive strengths ranged from about 0.5 MPa at early ages to about 4.5 MPa at later ages, but are not shown in the graphs for ease of presentation.

FIG. 10: TG and DTG curves of: (a) 1-day hydrated binary and ternary pastes including limestone (LS) and fly ash (FA)/metakaolin (MK), (b) 28-day hydrated pastes including fly ash/metakaolin, (c) 28-day hydrated ternary blends with about 10% 0.7 μm limestone, and (d) 28-day hydrated ternary blends with about 20% 3 μm limestone. Representative data is shown. The uncertainty in the mass loss was less than about 5% for duplicate measurements made at the same age.

FIG. 11: Residual calcium carbonate contents in the limestone powder modified pastes after 1 and 28 days of hydration. The uncertainty in the residual calcium carbonate fractions was in the range of about 3-5% for duplicate samples tested at the same age.

FIG. 12: Heat flow curves for the limestone modified pastes at 28 days of hydration.

FIG. 13: Non-evaporable water and CH contents of: (a) binary mixtures including limestone (LS) or fly ash (FA)/metakaolin (MK), and (b) ternary blends of limestone and fly ash/metakaolin.

FIG. 14: Representative results of simulations showing volumetric evolution of solid phases as a function of sulfate-to-alumina ratio in a pure gypsum-aluminate system.

FIG. 15: Solid phase assemblage of about 95% OPC+about 5% metakaolin (mass basis) paste as a function of extent of reaction of metakaolin.

FIG. 16: Solid phase assemblage of about 90% OPC+about 10% metakaolin (mass basis) paste as a function of extent of reaction of metakaolin.

FIG. 17: Solid phase assemblage of about 85% OPC+about 15% metakaolin (mass basis) paste as a function of extent of reaction of metakaolin.

FIG. 18: Solid phase assemblage of about 65% OPC+about 5% metakaolin+about 30% limestone (mass basis) paste as a function of extent of reaction of metakaolin.

FIG. 19: Solid phase assemblage of about 60% OPC+about 10% metakaolin+about 30% limestone (mass basis) paste as a function of extent of reaction of metakaolin.

FIG. 20: Solid phase assemblage of about 55% OPC+about 15% metakaolin+about 30% limestone (mass basis) paste as a function of extent of reaction of metakaolin.

FIG. 21: Compressive strength at 28 days of hydration of OPC pastes prepared at different levels of replacement by metakaolin and quartz (for comparison). Here, 0% pertains to the reference (pure OPC) system.

FIG. 22: Compressive strength at 90 days of hydration of OPC pastes prepared at different levels of replacement by metakaolin and quartz (for comparison).

FIG. 23: Compressive strength at 28 days of hydration of OPC+about 30% limestone pastes prepared at different levels of replacement by metakaolin and quartz (for comparison). Here, 0% pertains to the reference (OPC+about 30% limestone) system.

FIG. 24: Compressive strength at 90 days of hydration of OPC+about 30% limestone pastes prepared at different levels of replacement by metakaolin and quartz (for comparison).

FIG. 25: Solid phase assemblage of about 95% OPC+about 5% alphabond (mass basis) paste as a function of extent of reaction of alphabond.

FIG. 26: Solid phase assemblage of about 90% OPC+about 10% alphabond (mass basis) paste as a function of extent of reaction of alphabond.

FIG. 27: Solid phase assemblage of about 85% OPC+about 15% alphabond (mass basis) paste as a function of extent of reaction of alphabond.

FIG. 28: Solid phase assemblage of about 65% OPC+about 5% alphabond+about 30% limestone (mass basis) paste as a function of extent of reaction of alphabond.

FIG. 29: Solid phase assemblage of about 60% OPC+about 10% alphabond+about 30% limestone (mass basis) paste as a function of extent of reaction of alphabond.

FIG. 30: Solid phase assemblage of about 55% OPC+about 15% alphabond+about 30% limestone (mass basis) paste as a function of extent of reaction of alphabond.

FIG. 31: Compressive strength at 28 days of hydration of OPC pastes prepared at different levels of replacement by alphabond and quartz (for comparison). Here, 0% pertains to the reference (pure OPC) system.

FIG. 32: Compressive strength at 90 days of hydration of OPC pastes prepared at different levels of replacement by alphabond and quartz (for comparison).

FIG. 33: Compressive strength at 28 days of hydration of OPC+about 30% limestone pastes prepared at different levels of replacement by alphabond and quartz (for comparison). Here, 0% pertains to the reference (OPC+about 30% limestone) system.

FIG. 34: Compressive strength at 90 days of hydration of OPC+about 30% limestone pastes prepared at different levels of replacement by alphabond and quartz (for comparison).

FIG. 35: Portlandite mass contents as determined through TG analyses. Here, 0% pertains to the reference systems.

FIG. 36: Limestone mass contents as determined through TG analyses. Here, 0% pertains to the reference systems.

FIG. 37: Extent of limestone reaction as determined from TG analyses. Here, 0% pertains to the reference systems.

FIG. 38: Side-by-side comparisons of portlandite mass contents (% on dry mass basis), as determined from TG analyses. The pastes include metakaolin as the aluminous source. Here, 0% pertains to the reference systems.

FIG. 39: Side-by-side comparisons of portlandite mass contents (% on dry mass basis), as determined from TG analyses. The pastes include alphabond as the aluminous source. Here, 0% pertains to the reference systems.

### DETAILED DESCRIPTION

### Overview

Embodiments of this disclosure provide systematic approaches to develop viable long-term solutions to reduce the use of cement in concrete and other cement products, such as cement pastes and mortars. In some embodiments, a motivation in this regard is to expand the use of powdered limestone and similar carbonaceous materials in concrete. This approach is deemed particularly attractive as the abundance of limestone and similar carbonaceous materials in nature propels them as desirable materials that can be used in isolation or in conjunction with other materials to achieve a high cement-reduction (or replacement) level in concretes, such as from about 16% to about 70%, from about 20% to about 70%, from about 25% to about 70%, from about 30% to about 70%, from about 35% to about 70%, from about 40 to about 70%, from about 45% to about 65%, or from about 45% to about 55% (mass basis). This approach, which emphasizes the application of multiple-material solutions, can optimize the use of natural-and-waste materials by selecting them for use in concrete based upon their constituent chemistry and availability to produce sustainable concretes with engineering properties as desired for infrastructure construction. These efforts can reduce the impact of: (1) cement production on CO₂ emissions and climate change, and (2) CO₂ taxation and environmental policy on the construction industry, which would impede growth in the infrastructure sector.

Some embodiments of this disclosure provide strategies to engineer sustainable concretes with a reduced cement content while maintaining properties (e.g., compressive strength at both early and later ages) comparable to those of traditional “pure-cement” concretes. In developing sustainable concretes including large quantities (on mass or volume basis) of cement replacement materials, strategies can involve relating the constituent chemistry and physical properties of the components to the rate of chemical reactions and the resultant liquid and solid phase assemblages. Also, the strategies can develop an understanding of the pore structure and its relation to the macroscopic engineering properties. In some embodiments, high replacement levels of cement can be achieved through the synergy and interaction of large quantities of limestone (or other carbonate-rich materials) when used individually or in combination with at least one supplementary cementing material (SCM). Specifically, limestone can be rendered a reactive component of a cementitious mixture, by manipulation of the overall cement (binder) chemistry. This allows for the use of limestone, which is otherwise chemically inert, as a reactive part of the binder. The approach in some embodiments is based on altering the cement chemistry to promote the formation of certain binder phases, which can provide strength and structure to the overall cementitious mixture. Some embodiments can be implemented by blending or inter-grinding cement (e.g., in the form of powder or clinker) and limestone, along with a SCM. The SCM can be a chemical activator to promote reactions with limestone (carbonate).

### Low-Clinker Factor Cements Using Reactive Limestone

In some embodiments, proportioning of sustainable concretes involves blending or otherwise incorporating limestone powder to cement. This strategy is particularly attractive as: (1) the wide-spread and abundant availability of limestone in the earth's crust allows for the incorporation of an ecologically inert material to replace a part of the cement in concrete, and (2) quarried limestone involves little processing other than crushing and powdering before use in concrete. This is a significant improvement compared to cement production because raw limestone powder utilization reduces CO₂ emissions associated with the decarbonation of the limestone in the cement kiln, and the energy involved for grinding quarried limestone is significantly lower than that involved to heat the cement kiln to about 1450° C.

Limestone powder can serve as a physical filler in cementitious mixtures. The increase in the effective water-to-cement ratio (dilution) facilitated by the use of limestone powder can result in enhanced early-age cement hydration (filler-effect). However, in addition to filler-effects, limestone addition can also induce chemical effects, which can be attributed to carbonate (CO₃²⁻) anion-substitutions in the monosulfoaluminate (SO₄²⁻AFm) phase to produce carboaluminate structures (CO₃²⁻AFm). According to some embodiments, AFm can refer to one or more members of a family of hydrated calcium aluminate hydrate phases (aluminate-ferrite-monosubstituent phases). Its crystalline layer structure can be derived from that of portlandite, Ca(OH)₂, but with about one third of the Ca²⁺ ions replaced by a trivalent ion, nominally Al³⁺ or Fe³⁺. The resulting charge imbalance gives the layers a positive charge, which is compensated by intercalated anions; the remaining interlayer space is filled with H₂O. In some embodiments, its general formula can be represented as [Ca₂(Al,Fe)(OH)₆].X.xH₂O, where X represents a monovalent ion or 0.5 of a divalent interlayer anion, and x represents the number of water molecules. While the SO₄²⁻AFm (Ca₄Al₂(OH)₁₂(SO₄).6H₂O, monosulfoaluminate) is the form most commonly encountered in cement-based mixtures, anion-substitutions of the sulfate by CO₃²⁻ can result in the formation of alternate AFm phases such as calcium monocarboaluminate (CO₃²⁻ AFm; Ca₄Al₂(OH)₁₂(CO₃).5H₂O) and calcium hemicarboaluminate (AFm including OH⁻ and CO₃²⁻ in about 2:1 molar ratio; Ca₄Al₂(OH)₁₃(CO₃)_{0.5}.5.5H₂O). The carbonate (CO₃²⁻) anion-substitutions can also enhance the quantity of ettringite (AFt; aluminate-ferrite-trisubstituted; trigonal crystalline compound that can be represented as (Ca₆Al₂(OH)₁₂(SO₄)₃.26H₂O)) formed due to the release of SO₄²⁻ species from the monosulfoaluminate phase, and can also increase the total solid volume of the reaction products formed due to increased (either, or both, hemi and mono) carboaluminate phase formation. This response can be related to the chemistry and mass-content of the reactive (e.g., cement, limestone, and chemical activator) components. Leveraging this chemistry and promoting the activation of carbonate-rich materials using suitable chemical activators can pave the way for the better utilization of abundant natural materials such as limestone (powder) as more than a filler in concrete.

Typically, portland cements are constituted to a sulfate-to-alumina (SO₃/Al₂O₃, SA, molar mass-basis) ratio ranging between about 0.5 and about 0.9. The SA ratio indicates the quantity/balance of (mono- and tri-) sulfoaluminate phases that can be produced in a cementitious mixture. Some embodiments provide the reduction of portland cement content in concretes, such as on the order of about 40-70% (mass basis) by: (1) the addition of particle-size classified limestone powders at high levels, such as ranging between about 20% and about 50% or about 25% and 50% (mass basis), and (2) altering the SA ratio of the binder by controlled additions of one or more aluminous-containing (or alumina (Al₂O₃)-containing) materials, such as calcined or non-calcined clays (e.g., Kaolin group, such as kaolinite, dickite, halloysite, and nacrite; calcined or dehydroxylated clays of Kaolin group, such as metakaolin; Smectite group, such as montmorillonite, nontronite, and saponite; Illite group, such as illite and clay-micas; Chlorite group; and other clays such as sepiolite and attapulgite), alternate cements (e.g., high-alumina cements or calcium aluminate cements), steel and aluminum slags, fly ash (Class F or other fly ash conforming to ASTM C 618), non-standard fly ashes such as CFBC fly ash (e.g., with high aluminate content and potentially incompatible with ASTM C 618), municipal waste incineration ash, aluminum dross, chemical agents (e.g., calcined aluminas and inorganic salts), and other hydratable aluminous (or alumina) sources. In some embodiments, suitable aluminous (or alumina) sources include those having an alumina content of at least about 30% by weight, such as at least about 35% by weight, at least about 40% by weight, or at least about 45% by weight, and up to about 95% by weight or more. The use of aluminous (or alumina) sources can amplify carboaluminate phase formation and, thus, aid in the development of sustainable concretes with significantly reduced cement contents. In place of, or in combination with, limestone, other carbonate sources can be used, such as other similar carbonaceous materials including but not restricted to magnesium carbonates, dolomite, high magnesium limestone, their variants and derivatives (either of natural or synthetic origin), and other carbonate-rich materials. In some embodiments, suitable carbonate (or calcium carbonate) sources include those having a calcium carbonate content of at least about 35% by weight, such as at least about 40% by weight, at least about 50% by weight, at least about 60% by weight, at least about 70% by weight, or at least about 80% by weight, and up to about 97% by weight or more. In some embodiments, suitable carbonate (or calcium carbonate) sources include those in powder form and having a median particle size in the range of about 0.1 μm to about 100 μm, such as from about 0.1 μm to about 20 μm, from about 0.1 μm to about 15 μm, from about 0.1 μm to about 10 μm, from about 0.1 μm to about 7 μm, from about 0.1 μm to about 5 μm, from about 0.1 μm to about 3 μm, or from about 0.5 μm to about 3 μm.

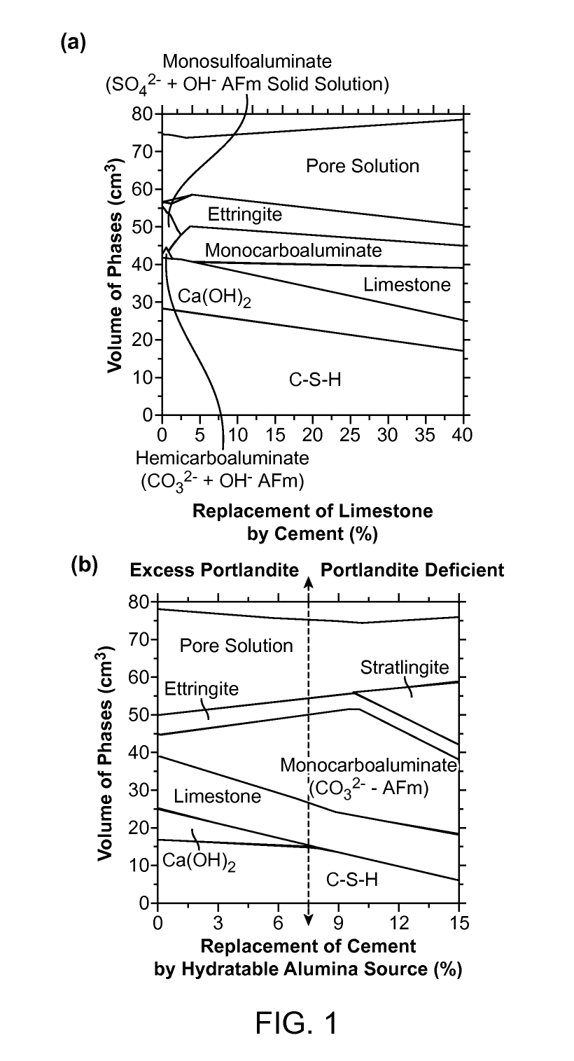

Aspects of the some embodiments can be further understood using a phase-description diagram developed using a thermodynamic modeling package (GEMS-PSI) as shown in FIG. 1. FIG. 1a considers the effects associated with varying the limestone content alone, for a cementitious mixture (water-to-binder mass ratio of about 0.50; SA=about 0.56) with 100% of cement by mass initially. As the cement is replaced with limestone (mass basis), the amount of C—S—H (calcium silicate hydrate) decreases, and the pore solution volume increases due to dilution (more free water is available in the mixture). However, the most interesting observations are related to the AFm phases. At low limestone replacement levels (e.g., low CO₃²⁻ contents), monosulfoaluminate and hemi-carboaluminate are present in the mixture. This is attributable to the absence of sufficient CO₃²⁻ species in the pore solution to fully displace the SO₄²⁻ and OH⁻ species included in the monosulfoaluminate and hemi-carboaluminate phases. However, as the limestone content in the mixture is systematically increased, the monosulfoaluminate and hemi-carboaluminate phases are replaced by the monocarboaluminate phase as sufficient carbonate species becomes available. In conjunction, there is an increase in the amount of ettringite. This occurs because SO₄²⁻ species displaced from the monosulfoaluminate in favor of CO₃²⁻ (to form monocarboaluminate) are able to combine with calcium (delivered sacrificially by Ca(OH)₂ or available as mobile ionic species in the pore solution) and aluminate species in the pore solution to form ettringite. However, beyond a point, the ettringite content of the system is noted to decrease monotonically (FIG. 1a).

FIG. 1b considers the role of alumina content in a cementitious mixture that initially includes 40% of limestone powder and 60% of cement by mass (water-to-binder mass ratio of 0.50). Here, the cement content is systematically reduced by replacement with hydratable alumina (SA ranges between about 0.56 at about 0% alumina and about 0.07 at about 15% alumina replacement (mass basis)). At high pH levels, the alumina provides readily-soluble aluminate ions (Al(OH)₄) in (aqueous) solution, which in the presence of sufficient calcium and carbonate species promotes the formation of monocarboaluminate phase. The role of the alumina content is revealed as the increased volume of monocarboaluminate formed (with increasing alumina replacement) promotes an increased solid hydrate volume as compared to mixtures which include alumina intrinsic solely to the cement (0% replacement in FIG. 1b). This increase in the solid hydrate volume that is observed with an increase in the alumina and carbonate contents ensures that binder systems with optimized alumina-and-carbonate contents demonstrate reduced porosity (and improved pore-filling) as compared to the 60% cement-40% limestone blend shown in the leftmost portion of FIG. 1b, despite significant reductions in the cement content. At about 7% replacement level of cement by hydratable alumina, the total porosity (e.g., ratio of volume of liquid to total volume) of the mixture is about 3.5% higher than the 100% cement system, despite a 47% reduction in the cement content. This is significant as the porosity can dictate the engineering properties and durability of the mixture.

Other than aspects related to phase assemblage information, the phase diagrams can also provide insights related to the durability response of the mixture. As an example, consider the portlandite-excess and deficient regions shown in FIG. 1b, where portlandite may be available or sacrificially consumed to promote the formation of carboaluminate phases. In some embodiments, this boundary can be used as a selection criterion for the extent of cement that can be replaced, since the presence of solid portlandite and the maintenance of portlandite saturation in the pore solution (pH ˜12.7) can mitigate against the depassivation of, and the consequent risk of corrosion of steel in, reinforced concrete elements. The simulations set forth in FIG. 1 indicate that, for some embodiments, cement replacement by a hydratable alumina source of about 7% (mass basis) when about 25% of the initial limestone powder has reacted is a “sustainable-binder,” which includes a reactive limestone component. In this case, the binder includes, on a mass basis, about 53% cement, about 7% alumina, and about 40% limestone for a potential 47% reduction in cement use. While this example considers hydratable alumina additions, similar or even higher levels of other aluminous sources can be incorporated in concrete with little or no compromise in engineering performance.

According to some embodiments, manufacturing of a “low cement content” concrete is carried out by incorporating at least one carbonate source (e.g., limestone) and at least one aluminous source (e.g., metakaolin) into a cementitious mixture including clinker (e.g., as a powder) and water. Desired amounts of either, or both, the carbonate source and the aluminous source can be added into a mixing water used to prepare the concrete. Either, or both, the carbonate source and the aluminous source can be added directly into a cement, or a suitably optimized cement clinker by addition or replacement as a powder. Examples of cements include portland cement, including ASTM C150 compliant ordinary portland cements (OPCs) such as Type I OPC, Type Ia OPC, Type II OPC, Type II(MH) OPC, Type IIa OPC, Type II(MH)a OPC, Type III OPC, Type IIIa OPC, Type IV OPC, and Type V OPC, as well as blends or combinations of two or more of such OPCs, such as Type I/II OPC, Type II/V OPC, and so forth. Other examples of cements include energetically modified cements, portland cement blends, and non-portland hydraulic cements including calcium aluminate/sulfoaluminate cements amongst others.

In some embodiments, at least one carbonate source (e.g., limestone) is incorporated in an amount w_{carbonate} greater than about 15% by weight of all solids (e.g., cement+carbonate source(s)+aluminous source(s)) (dry mass basis) combined with water to form a cementitious mixture, such as at least or greater than about 20% by weight, at least about 23% by weight, at least about 25% by weight, at least about 27% by weight, at least about 30% by weight, at least about 33% by weight, or at least about about 35% by weight, and up to about 40% by weight, up to about 45% by weight, or more. For example, w_{carbonate} can be in the range of 15%<w_{carbonate}≦45%, 20%<w_{carbonate}≦45%, 20%<w_{carbonate}≦40%, 20%<w_{carbonate}≦35%, or 20%<w_{carbonate}≦30%. In some embodiments, two or more different carbonate sources are incorporated in a combined amount w_{carbonate,combined} greater than about 15% by weight of all solids (e.g., cement+carbonate source(s)+aluminous source(s)) (dry mass basis) combined with water to form a cementitious mixture, such as at least or greater than about 20% by weight, at least about 23% by weight, at least about 25% by weight, at least about 27% by weight, at least about 30% by weight, at least about 33% by weight, or at least about about 35% by weight, and up to about 40% by weight, up to about 45% by weight, or more. For example, w_{carbonate,combined} can be in the range of 15%<w_{carbonate,combined}≦45%, 20%<w_{carbonate,combined}≦45%, 20%<w_{carbonate,combined}≦40%, 20%<w_{carbonate,combined}≦35%, Or 20%<w_{carbonate,combined}≦30%.

In some embodiments, at least one aluminous source (e.g., metakaolin) is incorporated in an amount wₐₗᵤₘᵢₙₒᵤₛ greater than about 1% by weight of all solids (e.g., cement+carbonate source(s)+aluminous source(s)) (dry mass basis) combined with water to form a cementitious mixture, such as at least or greater than about 3% by weight, at least about 5% by weight, at least about 7% by weight, at least about 10% by weight, at least about 13% by weight, at least about 15% by weight, or at least about about 17% by weight, and up to about 20% by weight, up to about 25% by weight, or more. For example, wₐₗᵤₘᵢₙₒᵤₛ can be in the range of 1%<wₐₗᵤₘᵢₙₒᵤₛ≦25%, 3%<wₐₗᵤₘᵢₙₒᵤₛ≦25%, 5%<wₐₗᵤₘᵢₙₒᵤₛ≦25%, 7%<wₐₗᵤₘᵢₙₒᵤₛ≦25%, 10%<wₐₗᵤₘᵢₙₒᵤₛ≦25%, or 10%<wₐₗᵤₘᵢₙₒᵤₛ≦20%. In some embodiments, two or more different aluminous sources are incorporated in a combined amount wₐₗᵤₘᵢₙₒᵤₛ,combined greater than about 1% by weight of all solids (e.g., cement+carbonate source(s)+aluminous source(s)) (dry mass basis) combined with water to form a cementitious mixture, such as at least or greater than about 3% by weight, at least about 5% by weight, at least about 7% by weight, at least about 10% by weight, at least about 13% by weight, at least about 15% by weight, or at least about about 17% by weight, and up to about 20% by weight, up to about 25% by weight, or more. For example, w_{aluminous,combined} can be in the range of 1%<w_{aluminous,combined}≦25%, 3%<w_{aluminous,combined}≦25%, 5%<w_{aluminous,combined}≦25%, 7%<w_{aluminous,combined}≦25%, 10%<w_{aluminous,combined}≦25%, or 10%<wₐₗᵤₘᵢₙₒᵤₛ≦20%.

In some embodiments, a cement is incorporated in an amount w_{cement} corresponding to about 30% to about 84% by weight of all solids (e.g., cement+carbonate source(s)+aluminous source(s)) (dry mass basis) combined with water to form a cementitious mixture, such as from about 30% to about 80%, about 30% to about 75%, about 30% to about 70%, about 30% to about 65%, about 30% to about 60%, about 35% to about 60%, about 45% to about 60%, about 35% to about 55%, or about 45% to about 55%. In some such embodiments, at least one carbonate source (e.g., limestone) is incorporated in an amount corresponding to at least about 40% of a remaining weight of solids (e.g., carbonate source(s)+aluminous source(s)) combined with the cement, such as at least about 45%, at least about 50%, at least about 55%, at least about 60%, or at least about 65%, and up to about 70%, up to about 75%, or up to about 80% or more. In some such embodiments, at least one carbonate source and at least one aluminous source are combined in a mass or weight ratio in a range of about 2:3 to about 6:1, such as from about 2:3 to about 5:1, from about 2:3 to about 4:1, from about 9:11 to about 3:1, from about 1:1 to about 7:3, from about 11:9 to about 7:3, from about 3:2 to about 7:3, or from about 13:7 to about 7:3.

Once formed, a cementitious mixture is cured (e.g., water-cured) to promote hydration reactions to form a resulting “low cement content” concrete. In some embodiments, curing includes reacting at least one carbonate source (e.g., limestone) to form one or more binder phases, and an extent of the carbonate source that is reacted (as determined based on a mass fraction (dry mass basis) of the carbonate source in the concrete after curing relative to a mass fraction (dry mass basis) of the carbonate source in the cementitious mixture before curing) is at least about 1%, such as at least about 3%, at least about 5%, at least about 7%, at least about 10%, at least about 13%, at least about 15%, at least about 17%, at least about 20%, at least about 23%, at least about 25%, at least about 27%, at least about 30%, at least about 40%, or at least about 50%, and up to about 80%, up to about 90%, or more. In some embodiments, the concrete includes one or more AFm phases, including a monocarboaluminate phase in an amount of at least about 1% by weight (dry mass basis), such as at least about 2% by weight, at least about 3% by weight, at least about 5% by weight, at least about 7% by weight, or at least about 10% by weight, and up to about 15% by weight or more. In some such embodiments, the concrete also includes stratlingite phase in an amount of at least about 0.1% by weight (dry mass basis), such as at least about 0.2% by weight, at least about 0.3% by weight, at least about 0.5% by weight, at least about 0.7% by weight, or at least about 1% by weight, and up to about 1.5% by weight or more. In some such embodiments, any portlandite phase is included in the concrete in an amount no greater than about 20% by weight (dry mass basis), such as no greater than about 17% by weight, no greater than about 15% by weight, no greater than about 13% by weight, no greater than about 10% by weight, no greater than about 7% by weight, or no greater than about 5% by weight, and down to about 1% by weight or less.

Surprisingly, and despite the high replacement level of cement by limestone, a resulting “low cement content” concrete is a high strength material, with a compressive strength of at least about 15 MPa, such as at least about 20 MPa, at least about 25 MPa, at least about 30 MPa, at least about 35 MPa, at least about 40 MPa, at least about 45 MPa, at least about 50 MPa, at least about 55 MPa, at least about 60 MPa, or at least about 65 MPa, and up to about 70 MPa, up to about 80 MPa, or more. In some embodiments, a resulting “low cement content” concrete has a compressive strength that is at least about 50% of a compressive strength of a reference (pure or 100% cement) concrete, such as at least about 55%, at least about 60%, at least about 65%, at least about 70%, at least about 75%, or at least about 80%, and up to about 85%, up to about 90%, or more. In some such embodiments, a porosity (e.g., a ratio of a volume of pores to a total volume) of the “low cement content” concrete is no greater than about 25%, such as no greater than about 23%, no greater than about 20%, no greater than about 18%, no greater than about 15%, or no greater than about 12%, and down to about 10%, down to about 8%, or less. The above-stated values of the porosity and the compressive strength can correspond to 1-day values, 7-day values, 14-day values, 28-day values, 56-day values, 90-day values, or values after longer periods of time.

### Examples

The following examples describe specific aspects of some embodiments of this disclosure to illustrate and provide a description for those of ordinary skill in the art. The examples should not be construed as limiting this disclosure, as the examples merely provide specific methodology useful in understanding and practicing some embodiments of this disclosure.

### Example 1

### Hydration and Strength Development in Ternary Portland Cement Blends Including Limestone and Fly Ash or Metakaolin

This example describes the influence of limestone particle size and the type of (partial) cement replacement material on hydration and the mechanical properties of cement pastes. Limestone powders having median particle sizes of about 0.7, about 3, and about 15 μm, at ordinary portland cement (OPC) replacement levels between about 0% and about 20% (volume basis), and two other replacement materials of differing reactivity (i.e., Class F fly ash or metakaolin) at replacement levels between about 0% and about 10% (volume basis), are used to proportion ternary binder formulations. Fine limestone accelerates early-age hydration, resulting in comparable or better 1-day compressive strengths, and increased calcium hydroxide (CH) contents as compared to pure cement pastes. The incorporation of metakaolin in conjunction with limestone powder alters the heat release (e.g., kinetic) response significantly. A ternary blend of this nature, with about 20% total cement replacement, demonstrates the highest 1-day strength and lowest CH content. Thermal analysis reveals distinct peaks corresponding to the formation of the carboaluminate phases after 28 days in the limestone-metakaolin modified pastes, whereas the incorporation of similar levels of fly ash does not change the response markedly. It is shown that the synergistic effects of limestone and metakaolin incorporation results in improved properties at early ages, while maintaining later age properties similar to that of traditional OPC systems.

There has been increased interest in the use of limestone powder as a cement replacement material. The use of an additional, reactive cement replacement material with appropriate chemical characteristics can facilitate the use of higher levels of limestone powder with little or no attendant property loss. Towards this goal, this example provides a systematic investigation of the effects of limestone fineness on the behavior of binders including supplementary cementing materials (SCMs). Specifically, this example develops a more detailed understanding of the influence of limestone fineness and additions on the behavior of ternary binder systems (cement+limestone+SCM), including SCMs of differing chemical reactivity. As such, this example focuses on clarifying the role of limestone fineness and the type of SCM (metakaolin or a Class F fly ash) on early and later-age behavior to understand the possibility to proportion ternary binder formulations that display properties similar to traditional OPC systems.

### EXPERIMENTAL

### Materials and Mixture Proportions

The materials used in this example include: a commercially available Type I/II OPC conforming to ASTM C 150, a Class F fly ash and metakaolin conforming to ASTM C 618, and limestone powder conforming to ASTM C 568. Limestone powders with three different nominal median particle sizes—about 0.7 μm, about 3 μm, and about 15 μm were used. The particle size distributions of the cement, limestone, fly ash, and metakaolin are shown in FIG. 2, and their chemical composition in Table 1. Cement was replaced by volume percentages of limestone powder varying between about 0% and about 40% in increments of about 10% (increments of about 5%, up to a total replacement of about 10% for the 0.7 μm limestone), and metakaolin and fly ash between about 0% and about 10% in increments of about 5%. In the remainder of this example, the percentages of limestone or other cement replacement materials reported are all on a volumetric basis, unless otherwise noted. The volumetric water-to-solids ratio (w/s)_{V} used for the mixtures is about 1/10; however since replacement was done by volume and all of the replacement materials are less dense than portland cement, the effective mass-based water to powder ratio of the blended mixtures varies between about 0.35 and about 0.38. Ternary blends including combinations of limestone and metakaolin or fly ash were also proportioned. Fly ash and metakaolin are used as OPC replacement materials because the aluminous nature of these materials favors the formation of the carboaluminate phases. OPC replacement levels of up to about 20% by limestone and up to about 10% by fly ash or metakaolin were implemented. These selections were made to attain a 28-day compressive strength within about 10% of the reference (plain cement) system. Overall, 42 different paste mixtures were proportioned and evaluated as part of this example.

TABLE 1
(% expressed on mass or weight basis)
Chemical compsition of the component materials.

| Component (%) | Cement | Fly ash | Metakaolin |
|---|---|---|---|
| SiO₂ | 21.0 | 58.4 | 51.7 |
| Al₂O₃ | 3.61 | 23.8 | 43.2 |
| Fe₂O₃ | 3.47 | 4.19 | 0.5 |
| CaO | 63.0 | 7.32 | — |
| MgO | 3.26 | 1.11 | — |
| SO₃ | 3.04 | 0.44 | — |
| Na₂O | 0.16 | 1.43 | — |
| K₂O | 0.36 | 1.02 | — |
| LOI | 2.13 | 0.50 | 0.16 |

Limestone powder contains 95-97% CaCO₃ as per the manufacturer.

### Experimental Methods

Isothermal calorimetry was carried out as per ASTM C 1702. The pastes were mixed externally as described in ASTM C305 prior to being loaded into the calorimeter. The time elapsed between the instant water was added to the powder(s) and the paste loaded into the calorimeter was about 2 min. Isothermal calorimetry was performed over a period of about 48-72 h. The powders were dry-blended using a hand mixer at low speed prior to adding water.

Compressive strengths were determined in accordance with ASTM C109 on 50 mm cubes stored in saturated limewater until the age of testing. Simultaneous thermal analysis (thermogravimetric analysis (TGA) and differential thermal analysis (DTA)) was carried out on selected pastes at ages of 1, 7, and 28 days to determine the calcium hydroxide (CH) and calcium carbonate (CC) contents. The tests were carried out in a pure nitrogen environment, at a flow rate of about 20 ml/s. A heating rate of about 10° C./min was employed, and the pastes were heated from ambient to about 950° C. The non-evaporable water content (wₙ) was calculated as the difference between the mass measurements at about 950° C. and about 105° C., normalized by the mass at about 950° C., and corrected for the loss on ignition of the cement powder (based on its mass fraction in the paste) and the calcium carbonate content (about 650-800° C.). This value was found to be very similar to the mass fraction of the paste remaining after heating to about 600° C. The CH contents were determined based on the mass change measured between temperatures in the DTA curve corresponding to the CH peak.

Results and Discussions

Early-Age Behavior of Binary and Ternary Cementitious Pastes:

Isothermal calorimetry was carried out on binary and ternary paste blends including several dosages of limestone powder of different particle sizes. The following sections provide insights into the influence of limestone fineness, dosage, and the synergistic effects of limestone powder and metakaolin or fly ash on the calorimetric response. The timing of the primary and secondary hydration peaks, their amplitudes, and the slopes of the acceleration and deceleration regimes are used to describe the influence of blend composition on the calorimetric response. Since a large set of mixtures is evaluated, a computer program was developed to extract these parameters from the calorimetric curves to expedite analysis. For ease of discussion, the data reported focuses on OPC replacements levels of about 10% and about 20% by limestone and about 10% by fly ash or metakaolin.

Effect of Limestone Fineness and Dosage on the Progress of Reactions:

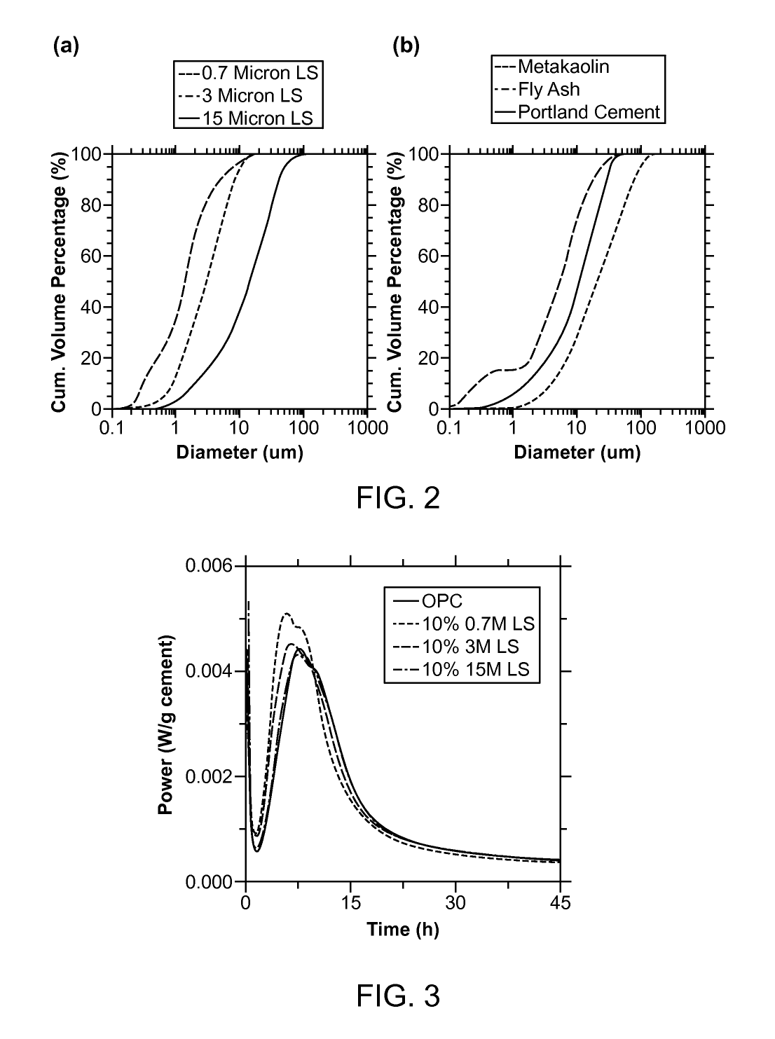

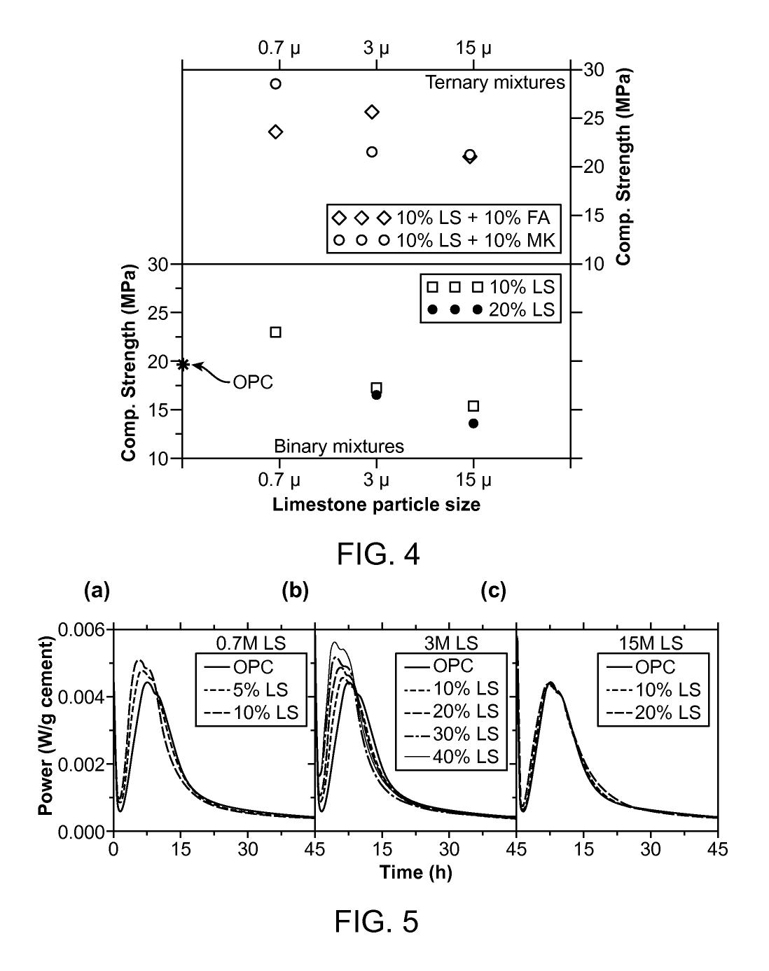

FIG. 3 depicts the heat release curves of the plain cement paste as well as those modified using about 10% limestone powder, for three different median particle sizes. It is evident that finer limestone powders accelerate reactions; increasing the magnitude of the heat release peak and shifting the peaks to earlier times. For example, for the finest limestone powder (about 0.7 μm), the main hydration peak is about 15% higher than that of the OPC paste, it appears about 25% sooner, and the slopes of the acceleration and deceleration regions are about 40% higher. The calorimetric response of the paste incorporating fine limestone also demonstrates a more pronounced shoulder on the main hydration peak. These effects can be attributable to the limestone powder accelerating hydration by enhancing the number of nucleation sites for the hydration products. With increasing coarseness of limestone powder, the heat release curve begins to mimic that of the plain paste. The differences in surface areas of the particles has implications in their dissolution rates, which reflect in the changes in the heat release response as observed. The effects of limestone size-dependent acceleration are supported by 1-day compressive strength datasets (FIG. 4), which show that the mixture including finer limestone powder has a higher 1 day strength than the OPC paste. With increasing limestone coarseness and dosage, the compressive strength is noted to reduce due to effects including increasing porosity and a progressively reducing mineral acceleration effect.

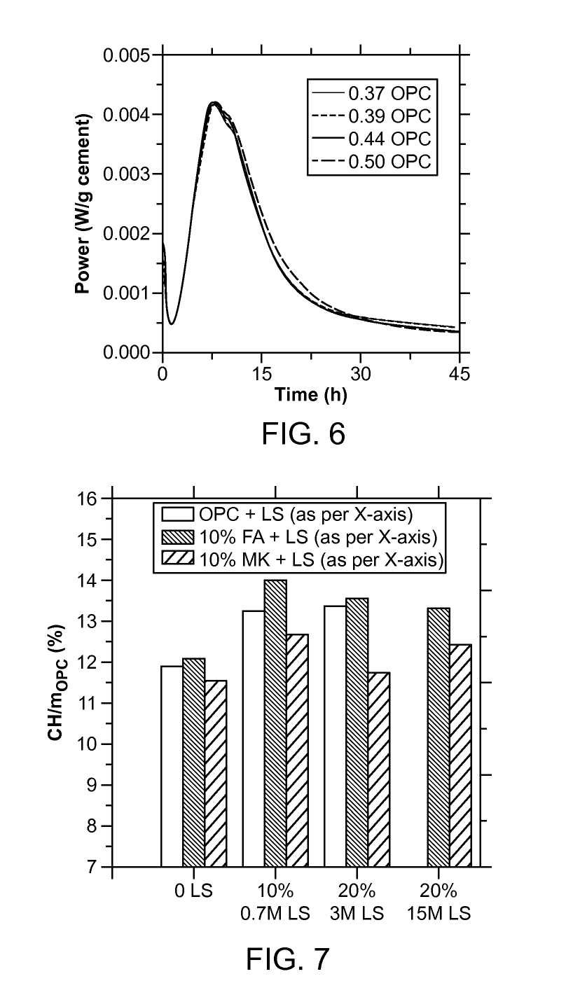

The influence of limestone dosage for varying particle sizes on the calorimetric response is shown in FIG. 5a-c. For the 0.7 μm and 3 μm size powders, an increase in the limestone content is found to significantly influence early reactions, with a larger peak amplitude, earlier occurrence of the peak, and increase in the slope of the acceleration and deceleration regions being noted in comparison to the plain cement paste. The calorimetric signatures are not substantially influenced by the presence of coarser limestone powders, irrespective of their contents in the paste. It is additionally noted that pastes proportioned at different water contents (dilution) to mimic water content increase with cement replacement show overlapping curves (FIG. 6). Notwithstanding the changes in water-to-cement weight ratio w/c, the heat response curves are largely identical, suggesting that the reaction kinetics at early ages is largely a filler effect rather than an influence of a change in the effective w/c.

FIG. 7 shows 1-day CH contents of selected pastes normalized by the mass fraction of OPC in the pastes. The normalized 1-day CH contents are higher for the 0.7 μm and 3 μm limestone-containing pastes, consistent with the acceleration effects noted in FIGS. 5a and b. For the paste including 15 μm limestone powder, the normalized CH is similar to that of the plain paste (not shown in graph), indicating little or no acceleration effects as supported by FIG. 5c.

Influence of Fly Ash and Metakaolin Replacements on the Progress of Reactions:

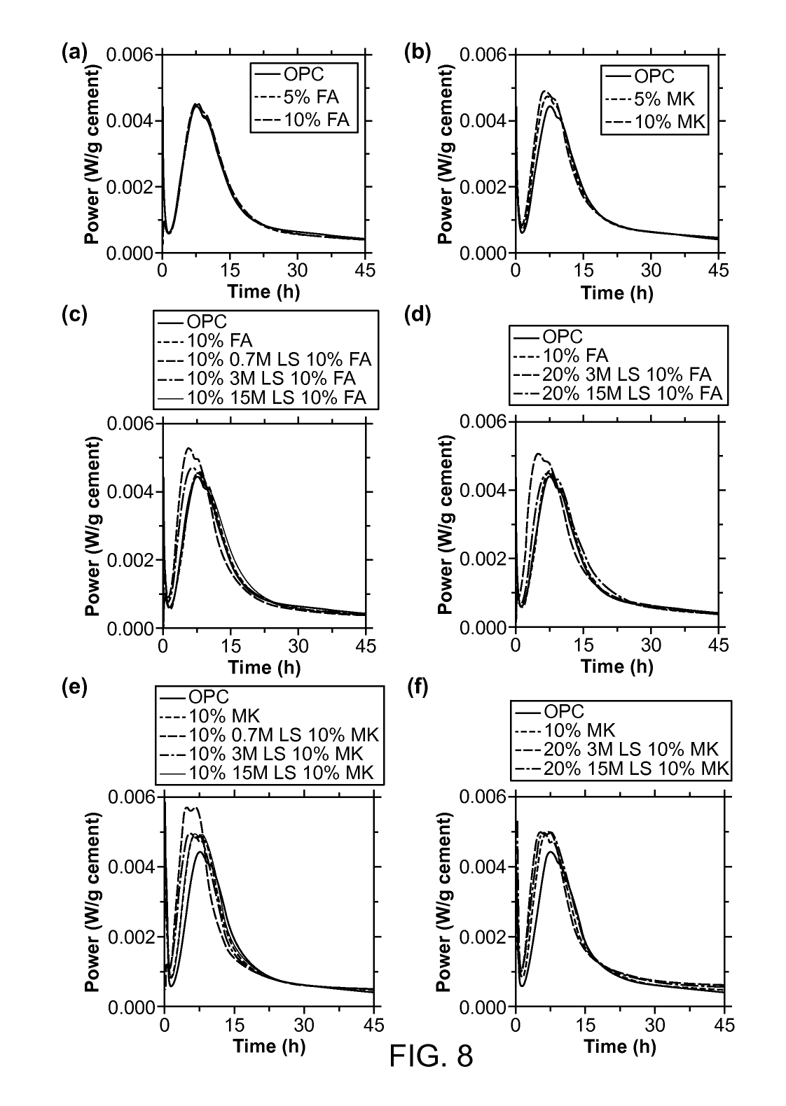

The influence of aluminous cement replacement materials such as fly ash and metakaolin (bulk Al₂O₃ contents of 24% and 43% respectively, mass basis) was examined for the early age heat release response of pastes including limestone powder. FIGS. 8a and b shows heat release for binary pastes containing about 5% or about 10% of fly ash or metakaolin as the sole cement replacement materials. The calorimetric response of fly ash modified pastes is very similar to that of the OPC paste (total heat released after about 48 h of about 233 J/g cement compared to about 236 J/g for OPC). In this regard, fly ash performs similarly to the coarser limestone powder (about 15 μm). This result indicates that the fly ash does not react substantially at early times. However, in the presence of metakaolin, the amplitude of the peak and the slope of the curve during the acceleration region increases with an increase in the metakaolin content. In addition, increasing the metakaolin dosage is also found to result in a more pronounced shoulder in the heat release response.

An analysis of the response of pastes including fly ash or metakaolin involves considerations of their particle sizes and reactivity. Fly ash has a median particle size similar to the coarsest limestone powder whereas the median particle size of metakaolin is much smaller (about 5 μm). When the heat release parameters for the about 10% metakaolin modified paste are compared to those of the OPC paste with about 10% of about 3 μm limestone powder, the samples are quite similar, demonstrating the influence of particle size. The peak amplitude is slightly higher for the metakaolin modified paste, but the peaks appear at virtually the same time. The normalized CH contents of the fly ash and metakaolin modified pastes are similar to that of the OPC paste at age of 1 day as observed from FIG. 7, suggesting that at early times, their hydration behavior is rather similar. For example, the about 10% fly ash modified paste (about 7.5% by mass) produces about 7% reduction in the 1-day actual (un-normalized) CH content, whereas for the about 10% metakaolin modified paste (about 7.9% by mass), the reduction in CH is about 11%. In other words, the reduction roughly scales with the OPC replacement level even though metakaolin incorporation results in a slightly higher reduction of CH. FIGS. 8a and b shows that, while the incorporation of fly ash does not change the reaction kinetics considerably, the use of metakaolin results in an acceleration of reactions. This is likely due to the early age pozzolanic reactions and CH consumption in metakaolin blended pastes, which are expected to be more reactive than fly ash or silica fume modified pastes

Progress of Reactions in Fly Ash/Metakaolin-Containing Limestone-Containing Pastes:

The calorimetric response of ternary blends including up to about 10% of fly ash or metakaolin with different particle sizes/dosages of limestone powder are discussed in this section. FIGS. 8c and d represents the effects of a combination of limestone powder and fly ash on the heat release response of cement pastes. FIG. 8c depicts the calorimetric response of systems including about 10% of limestone and fly ash whereas FIG. 8d shows the response of the systems including about 20% limestone powder augmented with about 10% fly ash. From both the figures, it can be noticed that the behavior of the ternary systems are different from those including fly ash as the sole cement replacement material. When the response of the systems including about 10% fly ash and about 10% limestone powder of varying sizes shown in FIG. 8c is compared to those including about 10% limestone powder alone (FIG. 3), it is noticed that the early age behavior of limestone powder modified pastes is not significantly modified by the presence of fly ash. To better facilitate these comparisons, Table 2 shows the parameters of the heat release curves of the plain, binary, and ternary mixtures. Comparing the about 10% limestone powder modified pastes with and without fly ash, the time of appearance of the main hydration peak and the shoulder, the peak amplitudes, and the slopes of the acceleration and deceleration regions are found to be very similar. While small amounts of limestone powder can have an influence on the reaction products and properties of OPC-fly ash blended systems, these are expected to be predominant at later ages as driven by the somewhat slow, time dependent dissolution of fly ash, which releases aluminate species into the pore solution. Increasing the limestone content of the ternary blends to about 20% as shown in FIG. 8d results in a behavior fairly similar to that of the about 20% limestone powder pastes without fly ash; although a small enhancement in the peak amplitude and slightly earlier appearances of the main hydration peak and the shoulder peak are noted.

For the pastes including limestone powder along with about 10% fly ash, FIG. 7 shows that increasing the limestone content increases the normalized CH content. Increasing coarseness of the limestone powder and increasing dosage reduces the normalized 1-day CH contents. However, it can be noticed that a further cement reduction of about 10% through fly ash incorporation in limestone powder modified concretes does not result in a corresponding change in the normalized CH contents, suggesting that the addition of fly ash does not measurably influence early age behavior. A comparison of the isothermal calorimetry results for limestone powder modified pastes with and without fly ash (FIGS. 4 and 7c and d) also indicate that the benefits of low amounts of fly ash addition, in conjunction with limestone powder, up to about 20% are not readily observed at early ages. This observation highlights the desire to select a more reactive aluminous cement replacement material, metakaolin, to be used in limestone powder modified systems so as to induce changes in early age behavior.

FIG. 8e shows the heat release response of pastes including about 10% limestone and about 10% metakaolin as (partial) cement replacement materials, while FIG. 8f shows the response of pastes including about 20% limestone powder augmented with about 10% metakaolin. The synergistic early age effects of small amounts of metakaolin in conjunction with about 10% or about 20% cement replacement by limestone powder are evident from these figures. For example: from FIG. 8e, it is noted that limestone powder in combination with metakaolin results in two distinct peaks (corresponding to C₃S and C₃A hydration) of similar magnitudes—indicating that aluminate hydration is potentially enhanced in the presence of metakaolin. These peak heights increase with decreasing median particle size of the limestone powder. The parameters of the heat release peaks of these ternary blends for a limestone replacement level of about 10% are shown in Table 2. The acceleration in hydration reaction in the presence of finer limestone powder and metakaolin as compared to limestone alone can be quantified based on the time of appearance of the peaks and the peak amplitudes provided in Table 2. That the secondary peak related to the aluminate reaction is substantially equal in magnitude to the primary peak in the ternary metakaolin blends (note that when limestone or metakaolin alone is used as a cement replacement material—FIGS. 4 and 7b—the primary and secondary peak amplitudes are different) suggests that the combination of finer limestone powder and metakaolin enhances the reaction kinetics at early ages in a more direct fashion than another combination of binary or ternary blends evaluated in this example.

The normalized 1-day CH contents of metakaolin modified pastes are found to be consistently lower than those of pastes including only limestone or limestone/fly ash as OPC replacement materials. The reaction of carbonate from limestone with Al from the OPC and metakaolin results in the formation of the mono/hemi-carboaluminate hydrates. Thermodynamic calculations indicate that the formation of the carboaluminates initiates as early as 1 day in limestone-containing systems, a point which can be confirmed by X-ray diffraction (XRD). The formation of carboaluminates (specifically, hemi-carboaluminate) consumes CH. While this action partly explains the reduced CH content observed in ternary blends including metakaolin, an additional contribution of the pozzolanic action of metakaolin at ages as early as 1 day may be another factor involved.

TABLE 2
Parameters of the calorimetric response for binary and ternary cement pastes.

| | | | | | Main hydration peak | | | | Slopes | |
|---|---|---|---|---|---|---|---|---|---|---|
| | | | | LS particle | Peak 1 | | Peak 2 | | Accel. | Decel. |
| OPC | FA | MK | LS | size (μm) | Time (h) | P (W/g) | Time (h) | P (W/g) | (W/g h) | (W/g h) |
| 100 | 0 | 0 | 0 | — | 7.5 | 0.0044 | — | — | 0.0009 | −0.0005 |
| 90 | 0 | 0 | 10 | 0.7 | 5.7 | 0.0051 | 7.6 | 0.0048 | 0.0013 | −0.0007 |
| | | | | 3 | 6.4 | 0.0046 | 8.2 | 0.0043 | 0.0010 | −0.0005 |
| | | | | 15 | 7.4 | 0.0044 | 9.1 | 0.0041 | 0.0008 | −0.0004 |
| 90 | 10 | 0 | 0 | — | 7.6 | 0.0046 | — | — | 0.0009 | −0.0004 |
| 80 | 10 | 0 | 10 | 0.7 | 5.6 | 0.0053 | 7.4 | 0.0050 | 0.0014 | −0.0007 |
| | | | | 3 | 6.3 | 0.0047 | 8.1 | 0.0045 | 0.0010 | −0.0005 |
| | | | | 15 | 7.6 | 0.0044 | 9.4 | 0.0042 | 0.0009 | −0.0004 |
| 90 | 0 | 10 | 0 | — | 6.4 | 0.0048 | 8.2 | 0.0047 | 0.0011 | −0.0006 |
| 80 | 0 | 10 | 10 | 0.7 | 4.9 | 0.0057 | 6.7 | 0.0057 | 0.0017 | −0.0009 |
| | | | | 3 | 5.5 | 0.0050 | 7.4 | 0.0050 | 0.0012 | −0.0005 |
| | | | | 15 | 6.5 | 0.0049 | 8.0 | 0.0049 | 0.0011 | −0.0006 |

Compressive Strength Development:

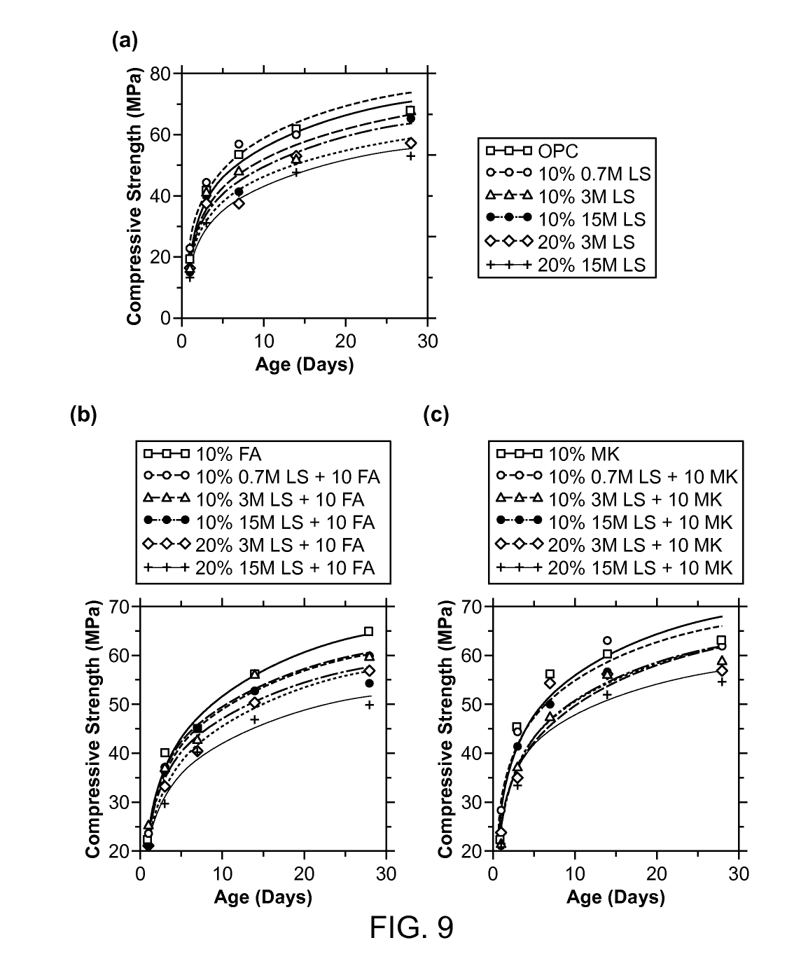

The compressive strengths of plain, binary, and ternary cement paste blends up to 28 days of hydration are shown in FIG. 9. The compressive strengths for the OPC-limestone powder pastes are shown in FIG. 9a. The paste including about 10% of 0.7 μm limestone powder shows the highest strengths until 14 days of age, after which it shows strengths similar to that of the plain paste. The enhancement in cement hydration facilitated by the fine particles of limestone powder is responsible for this effect. With increasing limestone content and median particle size, the compressive strengths at all ages are found to reduce. The reduction is not very prominent at early ages except for the higher replacement levels with the coarser limestone powder, due in part to mineral acceleration effects being able to partially compensate for the effects of OPC replacement. However, for the 15 μm limestone powder modified paste, an about 20% replacement of cement by limestone powder results in about 21% strength loss at 28 days, attesting to the effects of OPC by coarse limestone powder on mechanical properties.

The compressive strength development of ternary blends including fly ash or metakaolin along with limestone powder is provided in FIGS. 9b and c respectively. The use of metakaolin with about 10% of the finer limestone powder provides compressive strengths similar to or higher than that of about 10% metakaolin modified cement pastes at the ages considered. Note that similar or higher strengths are achieved in this case even when the cement replacement level in the ternary blend is double that of the binary blend. However, for a similar paste in which fly ash is used, the compressive strengths are generally substantially lower than the about 10% metakaolin modified paste—demonstrating the synergistic effects of the use of fine limestone powder with metakaolin. A comparison of FIGS. 9b and c shows that for the same level of cement replacement with limestone powder of a given particle size, mixtures including metakaolin have marginally higher strengths (of the order of about 5%) at all ages than the plain paste. For a given total cement replacement level, the ternary blends (including fly ash/metakaolin with limestone powder) demonstrate higher 28 day strengths than the corresponding OPC-limestone blends. This can be attributed to the combined effects of: (1) carboaluminate formation and ettringite stabilization and (2) the pozzolanic reactions, which would increase the solid volume of the hydrates and reduce the porosity in the system.

Thermal Analysis of Pastes: Influence of Limestone and Fly Ash/Metakaolin:

Analysis of Thermogravimetric (TG) and Differential Thermogravimetric (DTG) Curves:

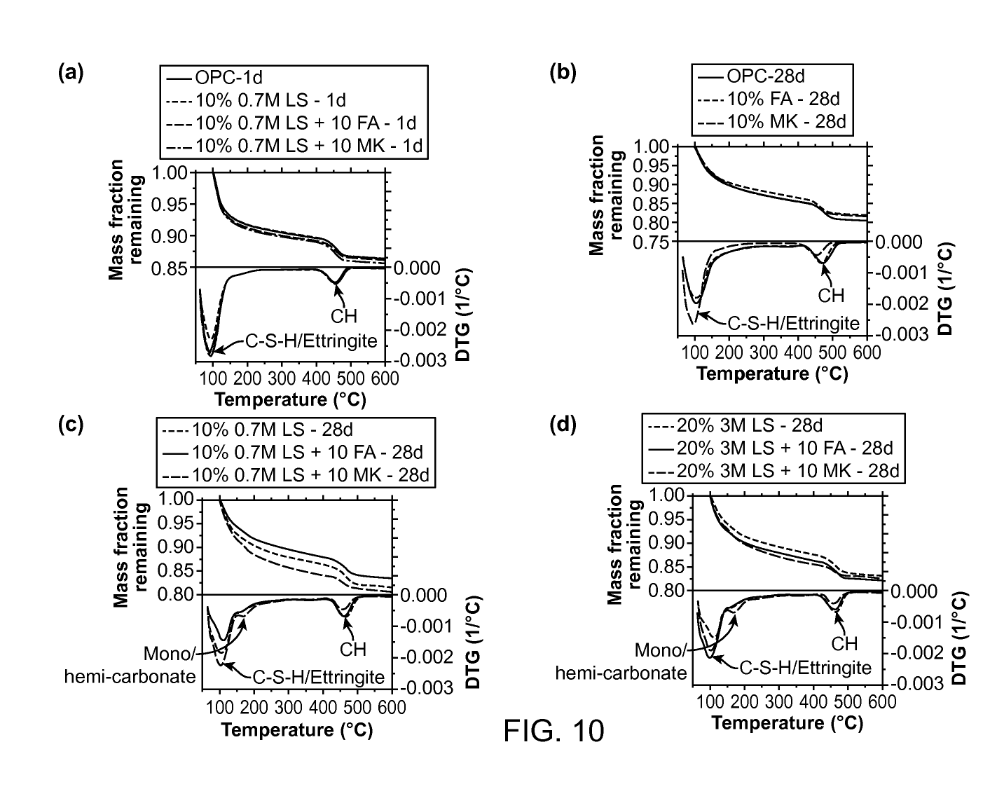

The earlier discussions in this example indicate that fine limestone powder in combination with metakaolin results in higher heat release and strength as compared to pastes composed with fine limestone and fly ash. TG and DTG curves for the 1-day hydrated systems are provided in FIG. 10a. It is noted that the residual mass fraction at about 600° C. is similar for the OPC paste and the about 10% 0.7 μm limestone powder modified paste with and without fly ash, indicating similarities in their wₙ contents. The wₙ is the highest for the ternary blend with metakaolin, indicating the enhanced reactivity of metakaolin+limestone blends at early ages—as also supported by the strength gain response and normalized CH contents.

The peak at about 100° C., linked to the decomposition of C—S—H and ettringite, is slightly higher for the ternary blend including metakaolin, potentially suggesting either, or both, increased amounts of C—S—H and the stabilization of ettringite in the presence of limestone. However, no monocarbonate is observed in the 1-day DTG curves, though slight (if any) formation would be expected at such early ages.

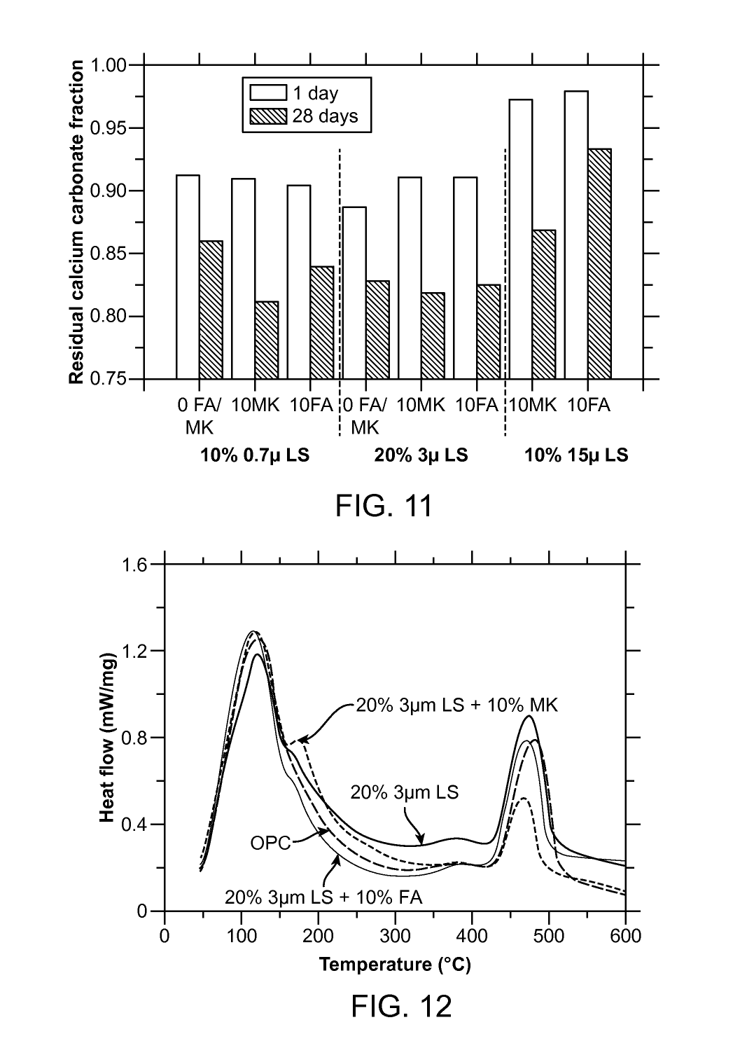

The TG and DTG curves of OPC, fly ash, and metakaolin modified pastes cured for 28 days are shown in FIG. 10b. The OPC and fly ash modified pastes show similar behavior at 28 days. The beneficial effects of metakaolin in terms of increasing the C—S—H content and decreasing the CH contents can be seen in this figure. This figure provides context to the TG and DTG analysis of ternary blends shown in FIGS. 10c and d. From the DTG curve of the ternary blend of about 10% 0.7 μm limestone and metakaolin shown in FIG. 10c, a distinct peak around 180° C. corresponding to the carboaluminate phases is observed. The formation of the carboaluminates, in conjunction with the pozzolanic reaction decreases the CH content even though the wₙ (and hence CH production) is the highest among all the three pastes shown in this figure. The formation of carboaluminate phases can be quantified using the residual amounts of CaCO₃ in the pastes. FIG. 11 shows the residual mass fraction of CaCO₃ in the pastes hydrated for 1 and 28 days, obtained by dividing the mass fraction of CaCO₃ from TG analysis by the initial mass fraction of CaCO₃ in the paste. It can be noticed from this figure that the residual calcium carbonate content is lower for the limestone modified pastes including metakaolin, confirming the increased consumption of limestone to form carboaluminate phases. For example, in the paste including about 10% 0.7 μm limestone by volume (about 8.7% by mass), about 14% of all the limestone added (or about 1.21% by mass of cement) reacts after 28 days. This value increases to about 16% (about 1.4% by mass of cement) and about 19% (about 1.65% by mass of cement) if the binder includes about 10% of fly ash or metakaolin by volume respectively in addition to limestone. For the paste including about 20% 3 μm limestone by volume (about 17.4% by mass), about 17% of all the limestone added (about 3% by mass of cement) is consumed after 28 days whereas this value increases to about 17.2% (about 3.1% by mass of cement) and about 18.2% (about 3.4% by mass of cement) in the presence of additional about 10% fly ash or metakaolin by volume.

The TG and DTG results for a larger replacement level of cement with 3 μm limestone powder along with metakaolin or fly ash is shown in FIG. 10d, which also shows a DTG peak corresponding to the presence of carboaluminates. Note that even at higher limestone replacement levels, the intensity of the carboaluminate peak is relatively unchanged as compared to FIG. 10c. This qualitatively shows that a higher replacement level of the 3 μm size limestone powder is able to provide a similar effect as a lower replacement level of the 0.7 μm limestone powder as far as carboaluminate formation is concerned. FIG. 11 confirms this observation where the residual carbonate contents in about 10% 0.7 μm limestone powder and about 20% 3 μm limestone powder are found to be similar. Such an effect was not noticed for the 15 μm size limestone powder as can be noted from FIG. 11.

For the limestone-fly ash ternary blends shown in FIGS. 10c and d, a very small peak is seen in the DTG curve corresponding to carboaluminate phases. In order to clearly distinguish between the effects of fly ash and metakaolin in limestone powder modified pastes, the heat flow corresponding to the thermal decomposition of the pastes is shown in FIG. 12. The thermal signature corresponding to carboaluminates is observed in this figure, with a noticeable minor peak at around 180° C. for the OPC-limestone-metakaolin blend. The minor peak is similar in size and much smaller for the limestone powder modified pastes with and without fly ash, and for the OPC paste. The fly ash content in these pastes is about 10%, which proves insufficient to form a significant volume of carboaluminates. A higher cement replacement level with fly ash (e.g., about 30-35%), which in turn means higher amount of aluminates, coupled with small amounts of limestone (e.g., about 5%) can result in a detectable peak in the DTG curves at around 180° C., and can result in later-age (e.g., beyond 28 days) properties comparable to OPC mixtures. However, a disadvantage of using such high volumes of fly ash may be the lack of early-age property development. In this example, it is shown that the combination of a reactive aluminate source with fine limestone powder can provide 1- and 28-day properties comparable to OPC mixtures for cement replacement levels of about 20% (by volume).

Bound Water and CH Contents:

If the total mass loss value at 600° C. (wₙ) is assumed indicative of a reasonable measure of the volume of reaction products, then the increased reaction product volume (even at about 20% less cement in the paste, and a reduced CH content) can be considered to be contributed by (i) accelerations in hydration facilitated by the filler effect of limestone powder, (ii) higher reactivity of metakaolin to form pozzolanic C—S—H, and (iii) the formation of carboaluminates through the reaction between the aluminates from metakaolin and carbonates from limestone powder. These effects compensate for the reduced cement content in ternary blend with metakaolin (and limestone) to provide a compressive strength similar to that of the OPC paste (FIG. 9).

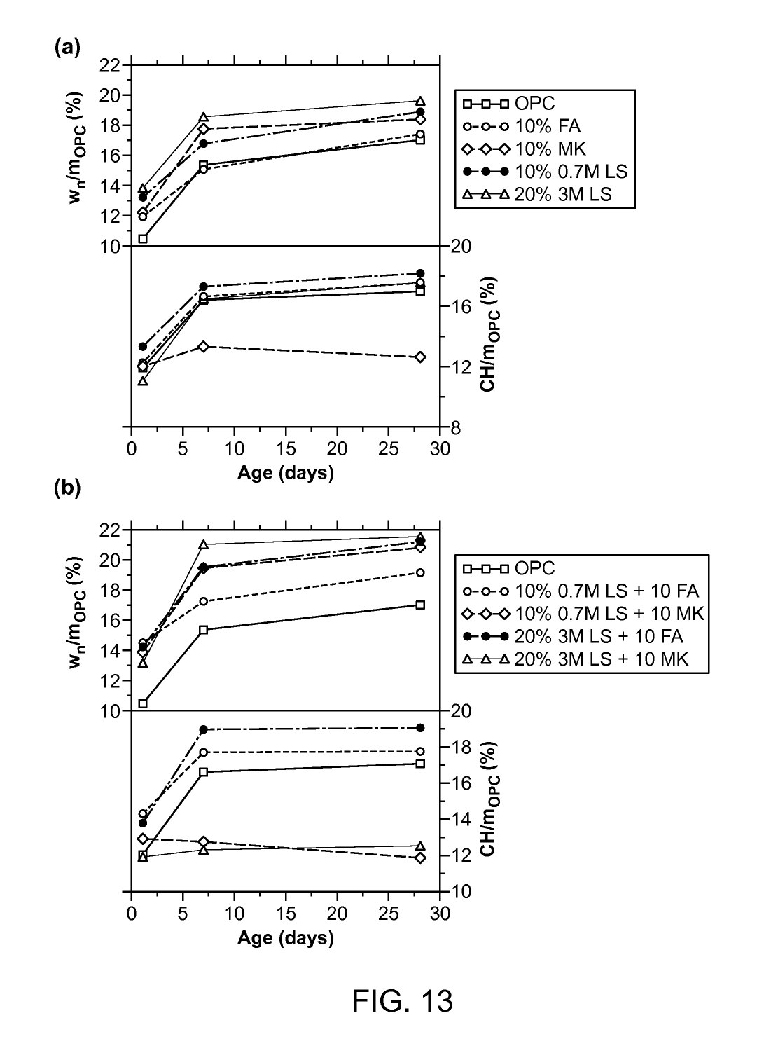

The non-evaporable water contents (wₙ) and the CH contents after 1, 7, and 28 days of hydration, normalized by the mass fractions of cement in the pastes are shown in FIGS. 13a and b for selected binary and ternary blend pastes. For all the pastes considered, a major fraction of the water is bound in the first 7 days of hydration. The OPC paste has the lowest normalized wₙ at all ages among all the binary pastes considered in FIG. 13a. The about 10% 0.7 μm limestone powder and the about 20% 3 μm limestone powder modified pastes show higher normalized wₙ and normalized CH contents at 1 and 28 days, attesting to the effect of fineness and amount of limestone powder on accelerating cement hydration (FIGS. 4 and 8). The about 10% fly ash modified paste shows a higher normalized wₙ than the OPC paste at 1 day, and similar wₙ at later ages. The enhancement in reactivity of cement provided by metakaolin and its own reaction at early ages result in the metakaolin modified paste showing a higher normalized wₙ than the OPC paste at all ages. It is also important to note from the lower panel of FIG. 13a that this paste has the lowest normalized CH content, with a significant lowering of CH contents at 28 days as compared to the other pastes. Higher wₙ and lower CH contents are indicators of the effective pozzolanic reaction of metakaolin starting at very early ages. For all the other pastes, the CH contents follow trends similar to that of wₙ. The normalized wₙ and CH contents of the ternary blend pastes are shown in FIG. 13b. Evident from this figure are the higher normalized wₙ values for the ternary blends as compared to the binary blends shown in FIG. 13a. The paste with overall about 30% cement replacement by volume (about 20% 3 μm limestone powder and about 10% metakaolin or fly ash) shows higher normalized wₙ at later ages, closely followed by the metakaolin modified and about 10% 0.7 μm limestone powder paste. The normalized CH content of the limestone-metakaolin blends shown here reduces or remain fairly constant with age while the normalized wₙ values for the corresponding pastes are seen to increase. For cement hydration, an increase in wₙ generally means an increase in CH. The reduction in CH can be viewed as an indication of the change in reaction products, such as due to pozzolanic reactions and the formation of the carboaluminate hydrates as shown in FIG. 10 through the TG and DTG curves. Evidence of reaction product modification at 28 days of hydration can be seen in both 0.7 μm and 3 μm size limestone powder pastes including metakaolin. A total cement replacement of about 20% (about 10% 0.7 μm limestone and about 10% metakaolin) results in a much higher 1-day compressive strength and comparable 28-day compressive strength as compared to the OPC paste. Such a beneficial effect is not observed for OPC-limestone-fly ash blends. Even cement replacement at about 30% level (about 20% 3 μm limestone powder, about 10% metakaolin) results in about 15% strength reduction as compared to the plain OPC paste. Small amounts of monocarboaluminate, shown to have a high modulus, can also play a role in mitigating strength loss in these mixtures. The incorporation of metakaolin is thus found to be beneficial in improving the properties of limestone powder modified systems at ages up to 28 days.

### CONCLUSIONS

This example describes the influence of limestone fineness and the reactivity of the alumina source on the early-age heat release response, the compressive strength and hydration products formed for cement pastes including limestone powder of three different median particle sizes or a combination of limestone powder and small amounts (about 10%) of fly ash or metakaolin. Fine limestone powders (about 0.7 and about 3 μm) were found to accelerate the early-age cement hydration at all the dosages studied. The paste with about 10% of 0.7 μm limestone powder was found to have better 1-day strength and increased normalized non-evaporable water (wₙ) and CH contents than the OPC paste. Increasing limestone coarseness and dosage reduced the compressive strength. Cement replacement by metakaolin in binary blends resulted in a higher heat release rate while replacement by fly ash did not produce large changes in the calorimetric response.

The calorimetric response of the pastes including limestone was not considerably modified by the presence of fly ash whereas significant changes in the calorimetric response was observed when metakaolin was used in conjunction with fine limestone powder (about 0.7 and about 3 μm). The enhanced reaction kinetics in ternary blends including about 10% 0.7 μm limestone powder and about 10% metakaolin resulted in the highest 1-day compressive strength, and the 1-day normalized CH content was among the lowest of all the evaluated pastes. While CH reduction can also be partially attributed to carboaluminate formation, it was not detected in the thermal decomposition signatures of these pastes. The enhanced aluminate phase reaction also can contribute to increased incorporation of Al³⁺ in the C—S—H at early ages rather than forming carboaluminates.

The fine limestone powder (about 0.7 and about 3 μm) modified pastes at about 10% cement replacement level showed compressive strengths comparable to those of OPC pastes until 28 days. The ternary blend of metakaolin along with about 10% 0.7 μm limestone powder resulted in compressive strengths that were higher than either of the corresponding binary blends, even at a higher overall cement replacement level. Such a response was not observed in the case of fly ash. The normalized wₙ at 28 days for the ternary blends of 0.7 and 3 μm limestone powder and metakaolin was higher than that of the OPC paste, the binary blends, and the ternary blends including fly ash. While the normalized wₙ of these pastes increased with age, the normalized CH contents were found to reduce or remain unchanged with age, indicating changes in reaction products. The DTG curves for the 28 day cured ternary pastes with both 0.7 and 3 μm limestone powder confirmed this through the observation of the presence of carboaluminates. Thus, this example sets forth the role of the overall chemical compatibility of cement replacement materials, with a view towards selecting the replacement material (in terms of its physical and chemical characteristics) to produce synergistic effects and optimal OPC replacement efficiency. As such, this example advances approaches to utilize multiple material solutions based on limestone and metakaolin to proportion ternary binders, dedicated to reducing the use of OPC in concrete.

### Example 2

### Reactive Limestone as a Strategy Towards Low-Clinker Factor Cements

Limestone (CaCO₃) can be used to partially replace OPC. Replacement by limestone can cause dilution and early age acceleration, but can also result in strength reduction. Reduction is strength is an issue, and it is proposed that this can be addressed by increasing aluminate content of cement

Materials and Mixture Proportioning:

OPC-based mixtures were prepared with a fixed water-to-solid ratio (w/s) of about 0.45 on a mass basis. The mixtures included: (1) plain OPC; (2) about 30% mass replacement of OPC by limestone; (3) about 5%-15% mass replacement of OPC by aluminous materials; and (4) about 30% mass replacement of OPC by limestone and an additional about 5%-15% replacement by aluminous materials. The aluminous materials were metakaolin or alphabond 300, which is a hydratable alumina binder available from Almatis B.V. Oxide compositions of the aluminous sources and cement used are set forth in Table 3.

TABLE 3
(% expressed on mass or weight basis)

| Oxide (%) | Type I/II OPC | Alphabond 300 | Metakaolin |
|---|---|---|---|
| SiO₂ | 21.45 | 0.33 | 54.19 |
| Al₂O₃ | 3.69 | 99.56 | 45.28 |
| Fe₂O₃ | 3.54 | 0.00 | 0.52 |
| CaO | 64.35 | 0.11 | 0.00 |
| MgO | 3.33 | 0.00 | 0.00 |
| SO₃ | 3.11 | 0.00 | 0.00 |
| Na₂O | 0.16 | 0.00 | 0.00 |
| K₂O | 0.37 | 0.00 | 0.00 |
| Total | 100.00 | 100.00 | 100.00 |

Gibbs Energy Minimization (GEMS):

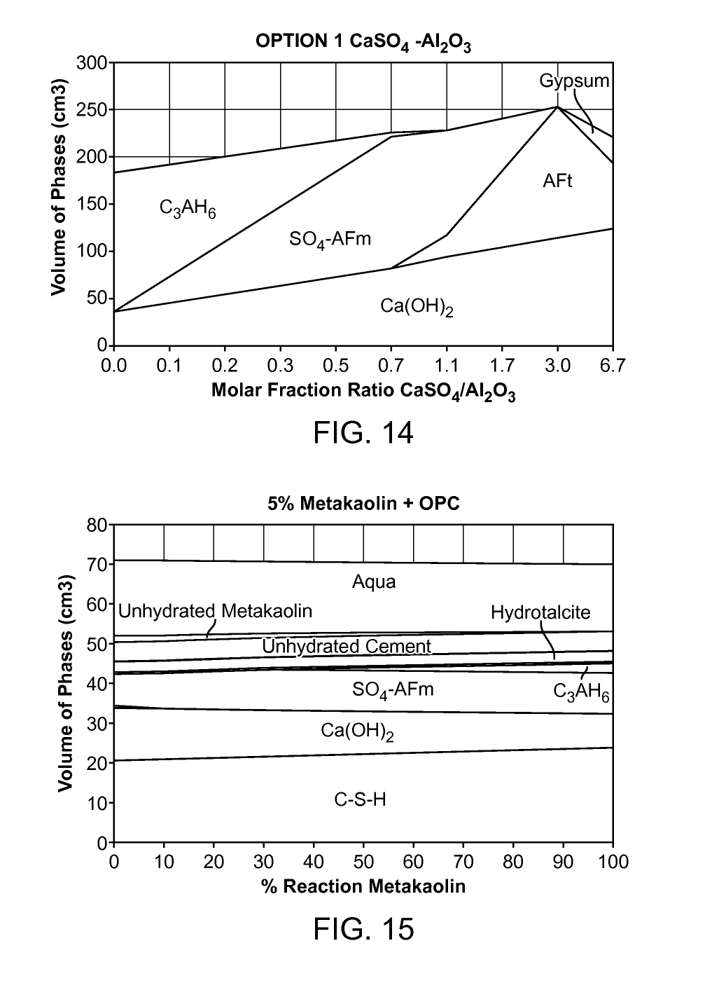

A geochemical modeling code was used to perform GEMS simulations, based on the principle of the minimization of the total Gibbs energy of a complex chemical system. Inputs to the stimulations included initial phase assemblage, and degree of hydration (DOH) of OPC fixed at about 83.5% at age=28 days. Outputs of the stimulations included equilibrium solid and liquid phase assemblage as function of extent of reaction. FIG. 14 are representative results of GEMS simulations showing volumetric evolution of solid phases as a function of sulfate-to-alumina ratio in a pure gypsum-aluminate system.

Influence of Metakaolin:

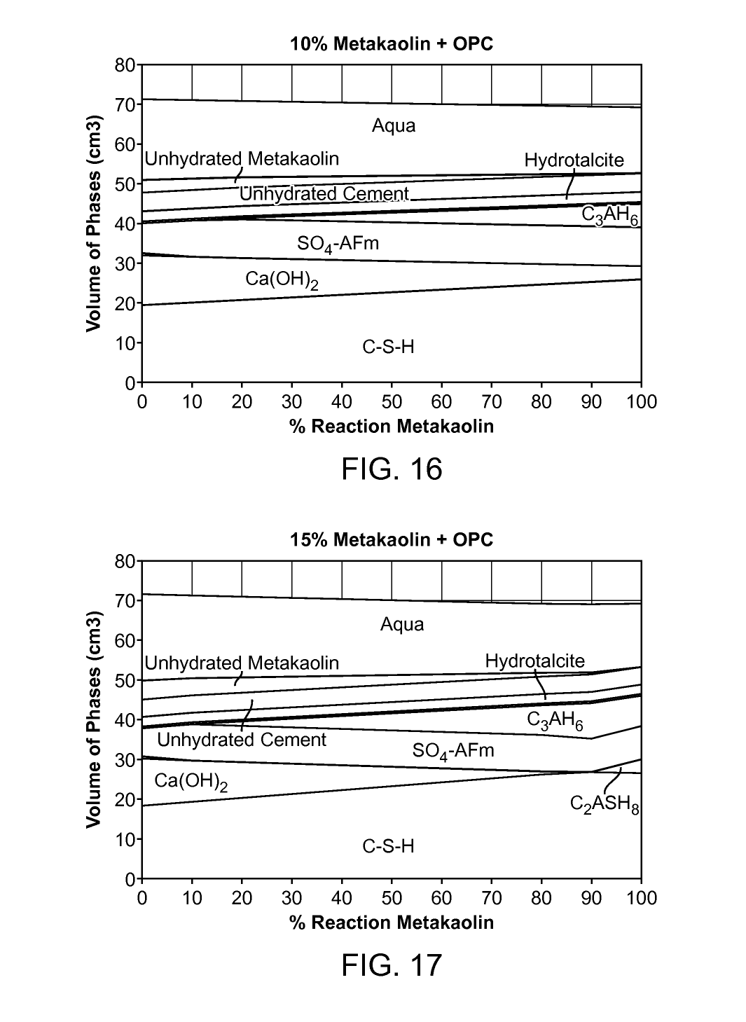

From the simulation results, an increase in metakaolin reduces portlandite (Ca(OH)₂ or CH) in the system. Metakaolin undergoes pozzolanic reaction with portlandite to form C—S—H (calcium silicate hydrate or xCaO.SiO₂.yH₂O). At higher replacements, portlandite is depleted, and formation of stratlingite (dicalcium aluminate monosilicate-8-hydrate or Ca₂Al₂SiO₇.8H₂O or 2CaO.Al₂O₃.SiO₂.8H₂O or C₂ASH₈) is initiated. Formation of hydrogarnet (tricalcium aluminate-6-hydrate or Ca₃Al₂(OH)₁₂ or 3CaO.Al₂O₃.6H₂O or C₃AH₆) is also noted to increase with an increase in metakaolin. FIG. 15 show solid phase assemblage of about 95% OPC+about 5% metakaolin (mass basis) paste as a function of extent of reaction of metakaolin. FIG. 16 show solid phase assemblage of about 90% OPC+about 10% metakaolin (mass basis) paste as a function of extent of reaction of metakaolin. FIG. 17 show solid phase assemblage of about 85% OPC+about 15% metakaolin (mass basis) paste as a function of extent of reaction of metakaolin.

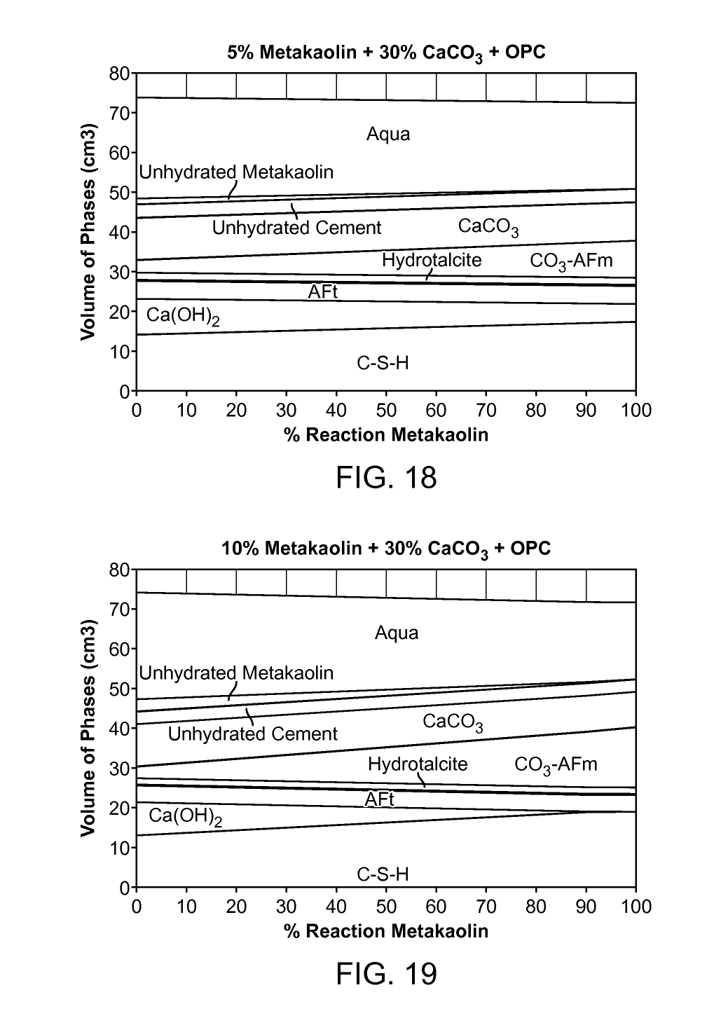

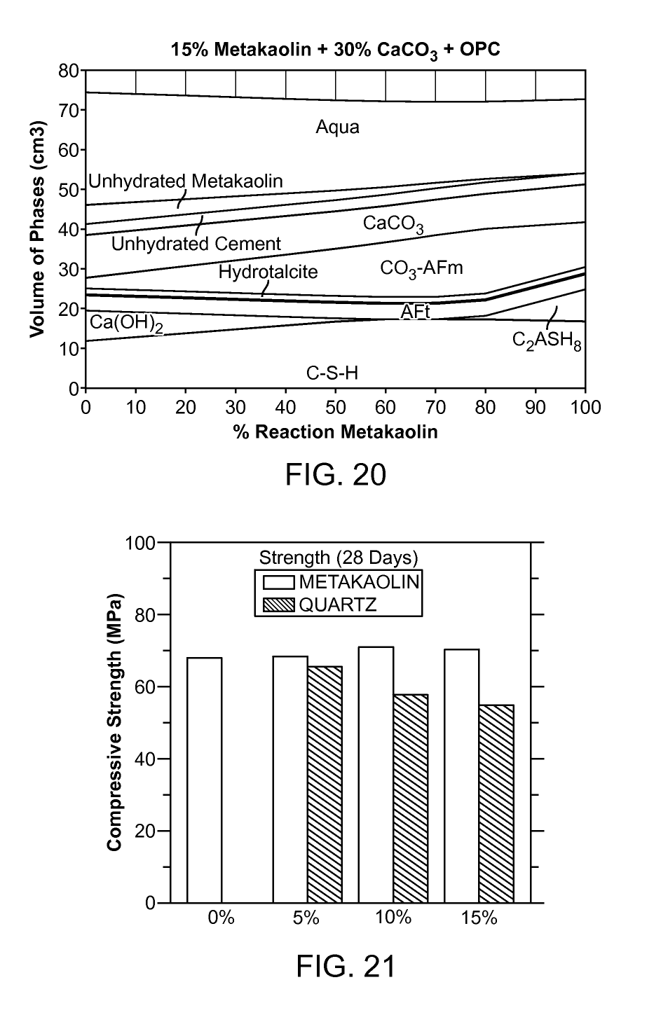

From the simulation results, addition of about 30% limestone favors the formation of CO₃-AFm over SO₄-AFm. Unreacted limestone can be reduced as metakaolin content increases. As more limestone reacts, formation of CO₃-AFm phase is enhanced. FIG. 18 show solid phase assemblage of about 65% OPC+about 5% metakaolin+about 30% limestone (mass basis) paste as a function of extent of reaction of metakaolin. FIG. 19 show solid phase assemblage of about 60% OPC+about 10% metakaolin+about 30% limestone (mass basis) paste as a function of extent of reaction of metakaolin. FIG. 20 show solid phase assemblage of about 55% OPC+about 15% metakaolin+about 30% limestone (mass basis) paste as a function of extent of reaction of metakaolin.

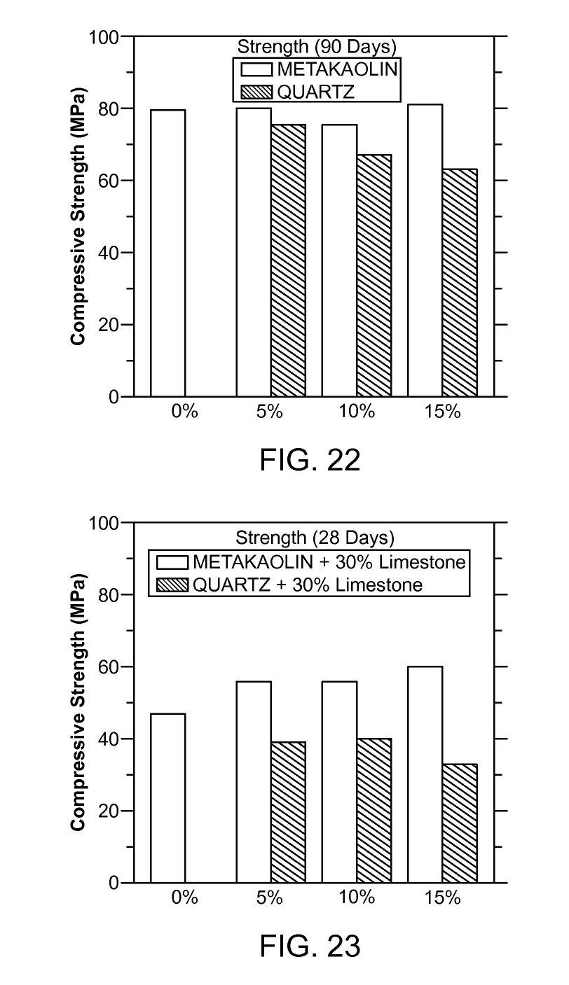

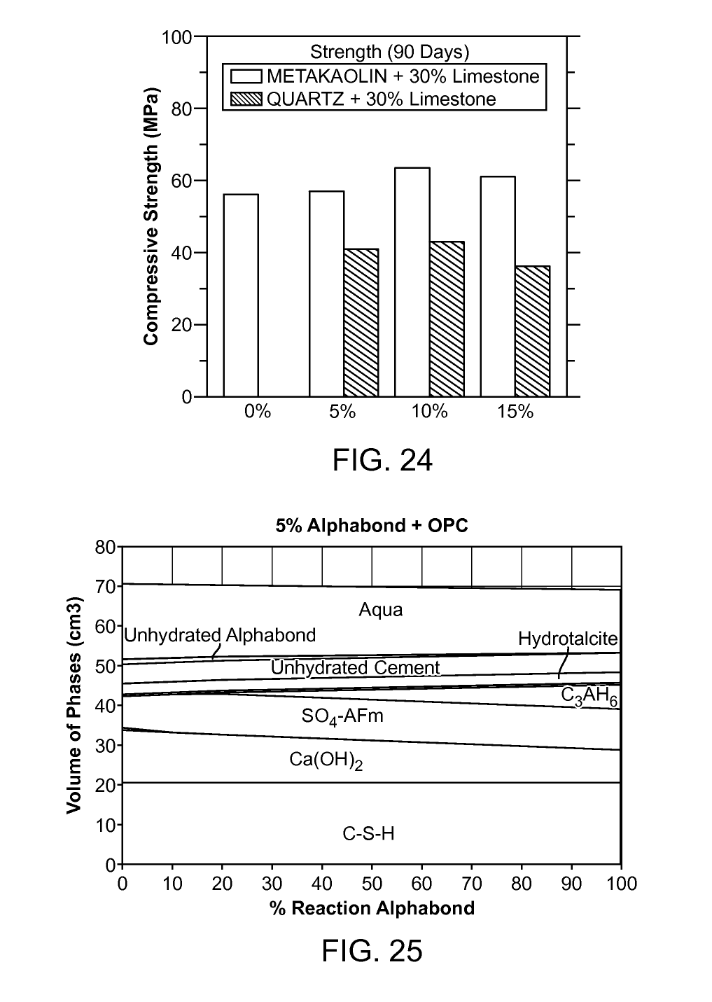

For the prepared mixtures, strength increases somewhat with increasing metakaolin replacement level. This strength enhancement can be attributed to the formation of more C—S—H as a result of pozzolanic reaction. FIG. 21 shows compressive strength at 28 days of hydration of OPC pastes prepared at different levels of replacement by metakaolin and quartz (for comparison), and FIG. 22 shows compressive strength at 90 days of hydration of OPC pastes prepared at different levels of replacement by metakaolin and quartz (for comparison). Here, 0% pertains to the reference (pure OPC) system. With about 30% limestone replacement, strength reduces substantially proportional to reduction in OPC content. FIG. 23 shows compressive strength at 28 days of hydration of OPC+about 30% limestone pastes prepared at different levels of replacement by metakaolin and quartz (for comparison), and FIG. 24 shows compressive strength at 90 days of hydration of OPC+about 30% limestone pastes prepared at different levels of replacement by metakaolin and quartz (for comparison). Here, 0% pertains to the reference (OPC+about 30% limestone) system.

Influence of Alphabond:

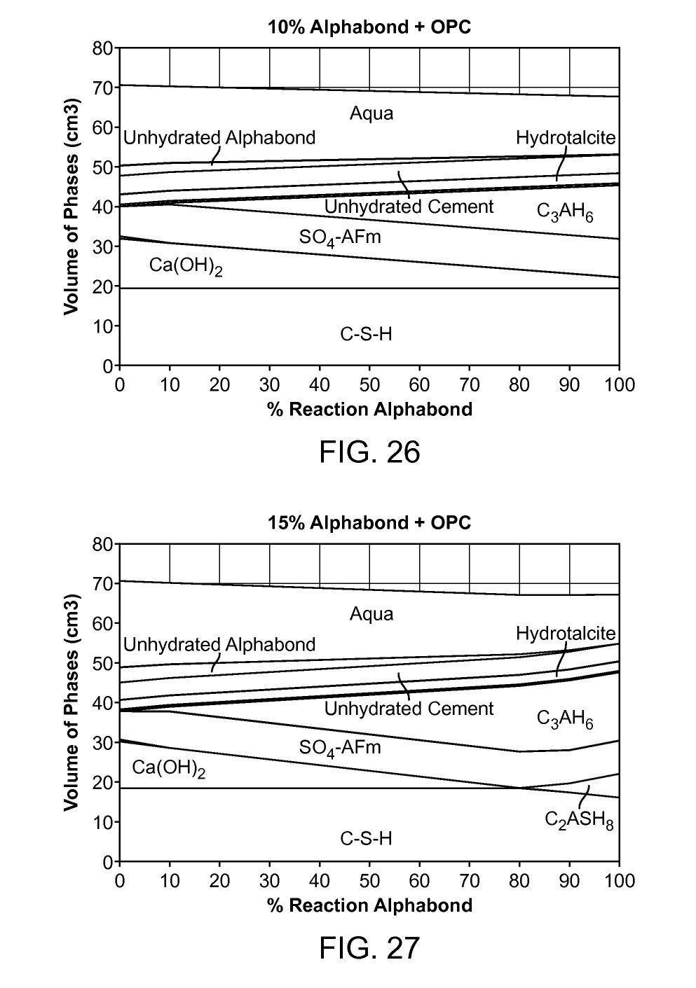

From the simulation results, an increase in alphabond suppresses formation of portlandite. At higher replacements, portlandite is depleted, and formation of stratlingite is initiated. At higher replacements, formation of C₃AH₆ is also enhanced. FIG. 25 show solid phase assemblage of about 95% OPC+about 5% alphabond (mass basis) paste as a function of extent of reaction of alphabond. FIG. 26 show solid phase assemblage of about 90% OPC+about 10% alphabond (mass basis) paste as a function of extent of reaction of alphabond. FIG. 27 show solid phase assemblage of about 85% OPC+about 15% alphabond (mass basis) paste as a function of extent of reaction of alphabond.

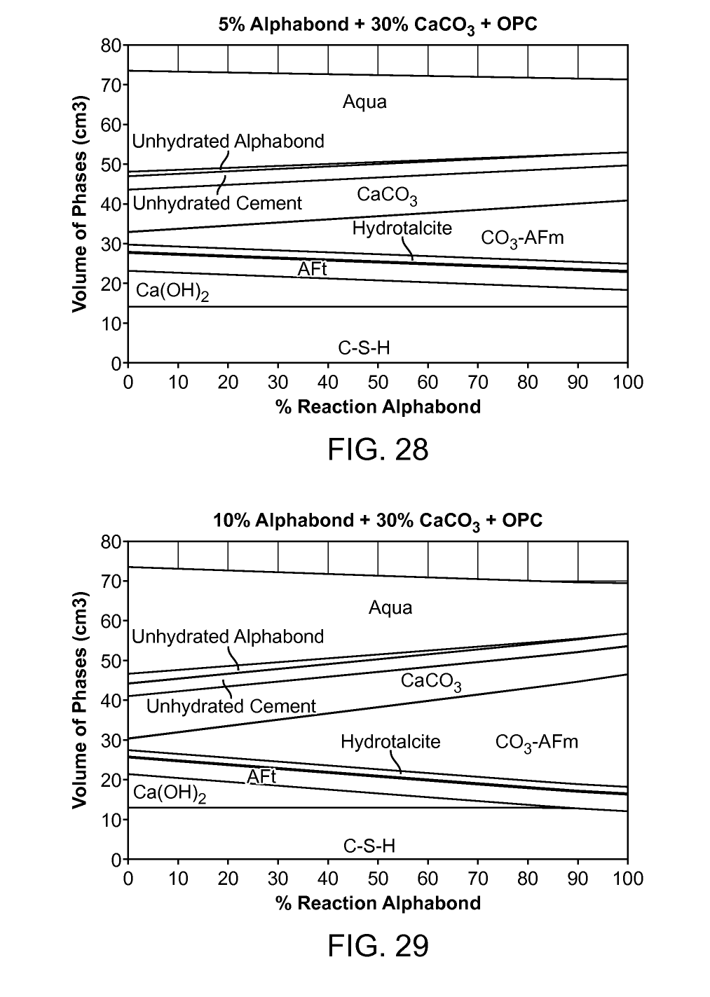

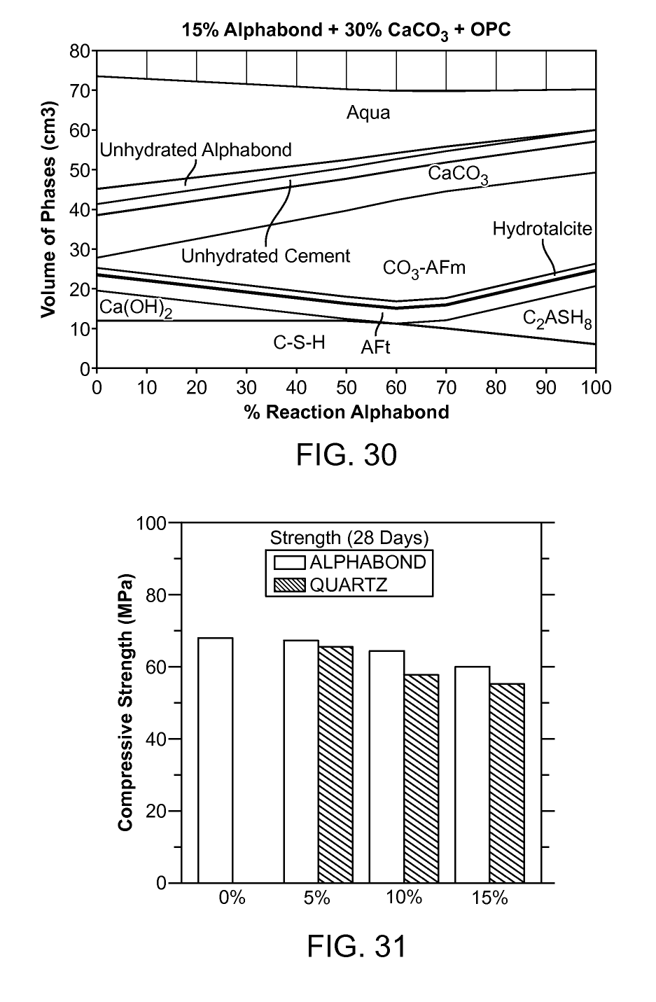

From the simulation results, addition of about 30% limestone favors the formation of CO₃-AFm over SO₄-AFm. Unreacted limestone can be reduced as alphabond content increases. As more limestone reacts, formation of CO₃-AFm phase is enhanced. FIG. 28 show solid phase assemblage of about 65% OPC+about 5% alphabond+about 30% limestone (mass basis) paste as a function of extent of reaction of alphabond. FIG. 29 show solid phase assemblage of about 60% OPC+about 10% alphabond+about 30% limestone (mass basis) paste as a function of extent of reaction of alphabond. FIG. 30 show solid phase assemblage of about 55% OPC+about 15% alphabond+about 30% limestone (mass basis) paste as a function of extent of reaction of alphabond.

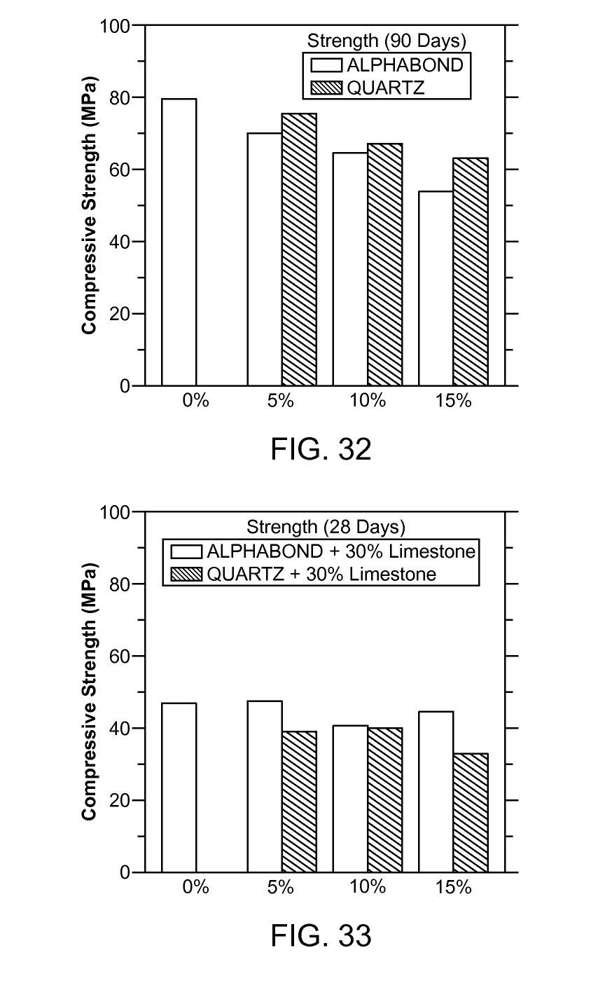

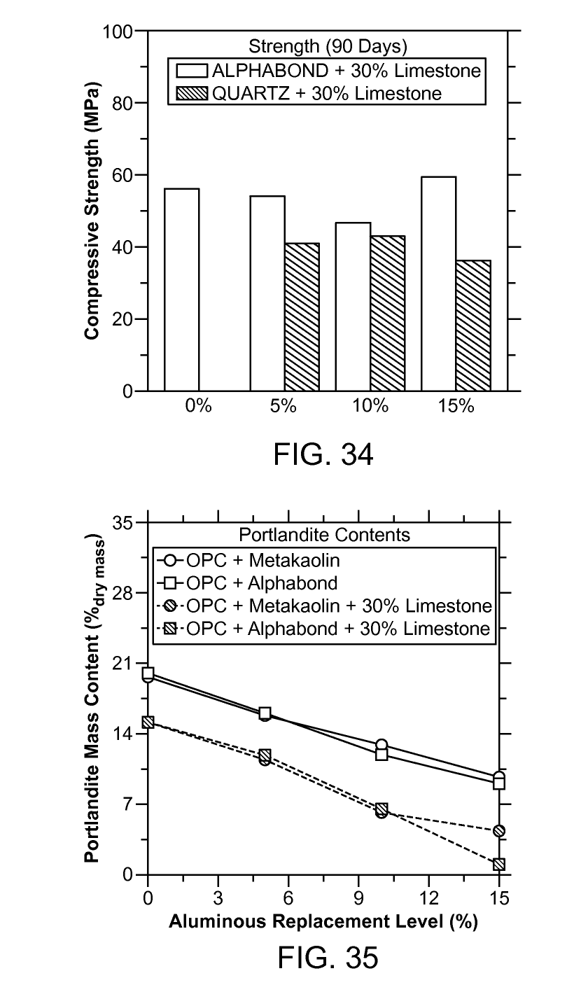

For the prepared mixtures, strength reduces with reduction in OPC by alphabond replacement. Strength values are higher than dilution values (quartz) at 28 days, but are lower at 90 days. FIG. 31 shows compressive strength at 28 days of hydration of OPC pastes prepared at different levels of replacement by alphabond and quartz (for comparison), and FIG. 32 shows compressive strength at 90 days of hydration of OPC pastes prepared at different levels of replacement by alphabond and quartz (for comparison). Here, 0% pertains to the reference (pure OPC) system. With about 30% limestone replacement, strength further reduces as a function of reduction in OPC content. FIG. 33 shows compressive strength at 28 days of hydration of OPC+about 30% limestone pastes prepared at different levels of replacement by alphabond and quartz (for comparison), and FIG. 34 shows compressive strength at 90 days of hydration of OPC+about 30% limestone pastes prepared at different levels of replacement by alphabond and quartz (for comparison). Here, 0% pertains to the reference (OPC+about 30% limestone) system.

Portlandite and Limestone Contents:

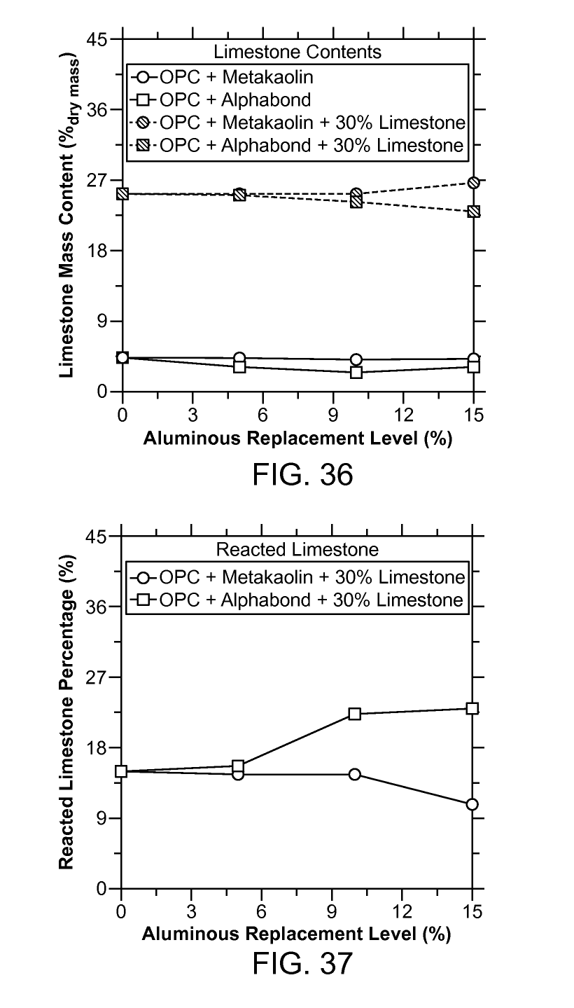

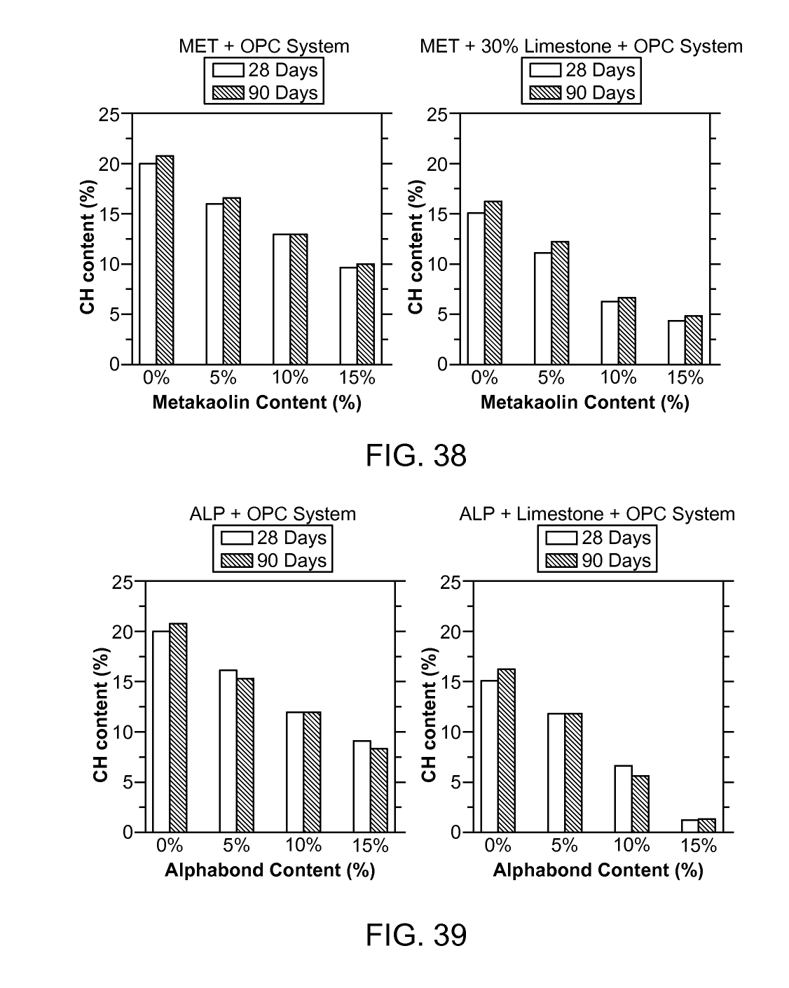

Portlandite contents reduce substantially proportional to OPC replacement levels for both metakaolin and alphabond. For corresponding replacement levels, alphabond causes limestone to react more as compared to metakaolin. FIG. 35 shows portlandite mass contents as determined through TG analyses, FIG. 36 shows limestone mass contents as determined through TG analyses, and FIG. 37 shows extent of limestone reaction as determined from TG analyses. FIG. 38 shows side-by-side comparisons of portlandite mass contents (% on dry mass basis), as determined from TG analyses. The pastes include metakaolin as the aluminous source. FIG. 39 shows side-by-side comparisons of portlandite mass contents (% on dry mass basis), as determined from TG analyses. The pastes include alphabond as the aluminous source. Here, 0% pertains to the reference systems.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, operation or operations, to the objective, spirit and scope of the invention. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations is not a limitation of the invention.

1. A manufacturing process of a low cement content concrete, comprising:
forming a cementitious mixture by combining a cement, a carbonate source, and an aluminous source, wherein the carbonate source is included in an amount greater than 20% by weight of solids combined in the cementitious mixture; and
curing the cementitious mixture to form the concrete.

2. The manufacturing process of claim 1, wherein the carbonate source is included in the amount of:
at least 25% by weight of solids combined in the cementitious mixture; or
at least 30% by weight of solids combined in the cementitious mixture.

3. The manufacturing process of claim 1, wherein the carbonate source is selected from limestone, dolomite, and magnesium carbonate.

4. The manufacturing process of claim 1, wherein the carbonate source is combined in a powder form and has a median particle size in the range of 0.1 μm to 100 μm.

5. The manufacturing process of claim 1, wherein the aluminous source is included in an amount of:
at least 5% by weight of solids combined in the cementitious mixture; or
at least 10% by weight of solids combined in the cementitious mixture.

6. The manufacturing process of claim 1, wherein the aluminous source is selected from clays, calcium aluminate cements, steel and aluminum slags, fly ash, incineration ash, aluminum dross, and calcined aluminas.

7. The manufacturing process of claim 1, wherein the carbonate source and the aluminous source are combined in a weight ratio in a range of 2:3 to 6:1.

8. The concrete formed by the manufacturing process of claim 1.

9. The concrete of claim 8, wherein the concrete has a compressive strength that is:
at least 60% of a compressive strength of a reference concrete in the absence of the carbonate source and the aluminous source; or
at least 70% of the compressive strength of the reference concrete in the absence of the carbonate source and the aluminous source.

10. A manufacturing process of a low cement content concrete, comprising:
forming a cementitious mixture by combining
a cement in an amount corresponding to 30% to 80% by weight of solids in the cementitious mixture,
an aluminous source, and
a carbonate source in an amount corresponding to at least 40% of a remaining weight of solids combined with the cement; and
curing the cementitious mixture to form the concrete.

11. The manufacturing process of claim 10, wherein the carbonate source corresponds to:
at least 50% of the remaining weight of solids combined with the cement; or
at least 60% of the remaining weight of solids combined with the cement.

12. The manufacturing process of claim 10, wherein the carbonate source is selected from limestone, dolomite, and magnesium carbonate.

13. The manufacturing process of claim 10, wherein the cement corresponds to:
30% to 70% by weight of solids in the cementitious mixture; or
45% to 60% by weight of solids in the cementitious mixture.

14. The manufacturing process of claim 10, wherein the cement is portland cement.

15. The manufacturing process of claim 10, wherein the carbonate source and the aluminous source are combined in a weight ratio in a range of 2:3 to 6:1.

16. The manufacturing process of claim 10, wherein the aluminous source is selected from clays, calcium aluminate cements, steel and aluminum slags, fly ash, incineration ash, aluminum dross, and calcined aluminas.

17. The concrete formed by the manufacturing process of claim 10.

18. The concrete of claim 17, wherein the concrete has a compressive strength that is:
at least 15 MPa;
at least 30 MPa; or
at least 45 MPa.
